(19) United States
(12) Patent Application Publication
(10) Pub. No.: US 2012/0243203 A1
(43) Pub. Date: Sep. 27, 2012

(54) VEHICLE LIGHT

(75) Inventors: Teruo KOIKE, Tokyo (JP); Ji-Hao Liang, Tokyo (JP)

(73) Assignee: Stanley Electric Co., Ltd., Tokyo (JP)

(21) Appl. No.: 13/426,318

(22) Filed: Mar. 21, 2012

(30) Foreign Application Priority Data
Mar. 23, 2011 (JP) 2011-064540

(51) Int. Cl. F21V 9/00; F21V 9/14

(52) U.S. Cl. 362/19; 362/510

(57) ABSTRACT

A vehicle light which uses a laser light source device and has a shorter dimension in an optical axis direction than conventional vehicle lights. The vehicle light comprises a laser light source device and an optical system configured so as to form a predetermined light distribution pattern. The laser light source device includes: a cylindrical light-guiding part having a diffusing surface set in a region other than a light-introducing surface; a phosphor arranged in a light-emitting region on an outer circumferential surface of the light-guiding part; a reflective film arranged in a region of the light-guiding part other than the light-introducing surface and the light-emitting region; and a laser light source that outputs a laser beam which is introduced into the light-guiding part from the light-introducing surface and enters the phosphor. The light-guiding part and the laser light source are arranged adjacent to each other.

### BACKGROUND OF THE INVENTION

1. Field of the Invention

The present invention relates to a vehicle light using a laser light source device and, in particular, to a vehicle light with a shorter dimension in an optical axis direction than conventional vehicle lights.

2. Description of the Related Art

Conventionally, in the field of vehicle lights, there have been demands for a high-luminance light source for illuminating the distance during nighttime by a light with sufficient intensity. To meet such demands, a vehicle light has been proposed (for example, refer to Japanese Patent Kokai No. 2010-232044: Patent Literature 1) which uses a laser light source device combining a laser light source with a phosphor (for example, a YAG phosphor) that emits light upon being excited by a laser beam (for example, a blue laser beam).

As shown in FIGS. 1 and 2, a vehicle light 200 described in Patent Literature 1 comprises a laser light source 210, a phosphor 220 that emits light upon being excited by a laser beam, a reflection surface 230 that reflects light radiated from the phosphor 220 to a forward direction.

With the vehicle light described in Patent Literature 1, the emission of light by the phosphor 220 upon being excited by a laser beam outputted by the laser light source 210 realizes a light source with a higher luminance than an LED or an HID (refer to FIG. 3).

### PATENT LITERATURE

PTL1: Japanese Patent Kokai No. 2010-232044

### SUMMARY OF THE INVENTION

However, since the vehicle light described in Patent Literature 1 is constructed such that the laser light source 210 and the phosphor 220 are arranged physically separated from each other (refer to FIGS. 1 and 2), there is a problem in that a dimension of the vehicle light 200 in an optical axis direction increases accordingly. This problem occurs because the emission of an irradiation flux with a Gaussian distribution emitted from the laser light source 210 that is a blue laser light source spreads out radially and light must be converged by arranging a collimating lens 240 between the laser light source 210 and the phosphor 220 in order to reduce an irradiation area of a converging beam that strikes the phosphor 220 located in a direction of travel of the converging beam and, accordingly, a greater optical length is required (refer to FIG. 1).

The present invention has been made in consideration of such circumstances, and an object thereof is to provide a vehicle light which uses a laser light source device and which has a shorter dimension in an optical axis direction than conventional vehicle lights.

In order to solve the problem described above, according to a first aspect of the present invention, a vehicle light comprises a laser light source device and an optical system configured so as to form a predetermined light distribution pattern using light radiated from the laser light source device, wherein the laser light source device includes: a light-guiding part which is a cylindrical light-guiding part made of a light-transmissive member, and has a surface that includes one end surface including a light-introducing surface for introducing a laser beam into the light-guiding part, an outer circumferential surface, and another end surface, a diffusing surface being set in a region on the surface other than the light-introducing surface; a phosphor arranged in a light-emitting region on the outer circumferential surface, the light-emitting region being enclosed by a first plane including a cylindrical axis of the light-guiding part and a second plane including the cylindrical axis of the light-guiding part and inclined by a predetermined angle with respect to the first plane; a reflective film arranged in a region on the surface other than the light-introducing surface and the light-emitting region; and a laser light source that outputs a laser beam which is introduced into the light-guiding part from the light-introducing surface, is diffused by the diffusing surface, exits the light-emitting region as a diffused light and enters the phosphor, and the light-guiding part and the laser light source are arranged adjacent to each other.

According to the first aspect of the present invention, since a compact laser light source device is used in which the light-guiding part (the light-introducing surface) and the laser light source are arranged adjacent to each other, a vehicle light can be constructed which has a shorter dimension in an optical axis direction than conventional vehicle lights.

In addition, according to the first aspect of the present invention, since a laser light source device with a higher luminance than an LED, a tungsten halogen lamp, or an HID lamp is used, a brighter light distribution than in a case where an LED, a tungsten halogen lamp, or an HID lamp is used is realized.

Furthermore, according to the first aspect of the present invention, since a laser light source device is used which is capable of securing a uniform luminance distribution and a uniform luminous color due to the action of the diffusing surface, a vehicle light can be constructed which is capable of realizing a light distribution with a uniform luminous color and without irregular color.

According to a second aspect of the present invention, irregularities with a vertical angle of 90 degrees or less are formed in the light-emitting region.

According to the second aspect of the present invention, due to the action of the irregularities having a vertical angle of 90 degrees or less, adhesion between the light-guiding part (light-emitting region) and the phosphor can be improved.

According to a third aspect of the present invention, in any of the vehicle lights described above, a polarizing filter for transmitting a laser beam outputted from the laser light source is arranged between the laser light source and the light-introducing surface.

According to the third aspect of the present invention, due to the action of the polarizing filter, an output fluctuation of the laser light source attributable to a laser beam which is diffused inside the light-guiding part and which exits from the light-introducing surface and enters the laser light source can be prevented.

According to a fourth aspect of the present invention, in any of the vehicle lights described above, an antireflective film configured by alternately laminating two layers with different refractive indexes is arranged between the laser light source and the polarizing filter.

According to the fourth aspect of the present invention, due to the action of the antireflective film, a transmitted light directed toward the light-guiding part (the light-introducing surface) can be strengthened.

According to a fifth aspect of the present invention, in any of the vehicle lights described above, the optical system includes: a reflection surface which is arranged in front of the laser light source device so that light radiated from the laser light source device enters the reflection surface and which reflects light incident from the laser light source device as a converging beam that forms a low-beam light distribution pattern; a projection lens that is arranged in front of the reflection surface so that light reflected by the reflection surface is transmitted through the projection lens; and a shade that is arranged between the reflection surface and the projection lens so as to block a part of the light reflected by the reflection surface and form a cutoff of the low-beam light distribution pattern.

According to the fifth aspect of the present invention, since a compact laser light source device is used in which the light-guiding part (the light-introducing surface) and the laser light source are arranged adjacent to each other, a projector-type vehicle light can be constructed which has a shorter dimension in an optical axis direction than conventional vehicle lights.

In addition, according to the fifth aspect of the present invention, since a laser light source device with a higher luminance than an LED, a tungsten halogen lamp, or an HID lamp is used, a vehicle light can be constructed which is capable of realizing a brighter light distribution (a low-beam light distribution pattern) than in a case where an LED, a tungsten halogen lamp, or an HID lamp is used.

According to a sixth aspect of the present invention, in the vehicle light according to any of the first to fourth aspects of the present invention, the optical system includes: a reflection surface which is arranged in front of the laser light source device so that light radiated from the laser light source device enters the reflection surface and which reflects light incident from the laser light source device as a converging beam that forms a high-beam light distribution pattern; and a projection lens that is arranged in front of the reflection surface so that light reflected by the reflection surface is transmitted through the projection lens.

According to the sixth aspect of the present invention, since a compact laser light source device is used in which the light-guiding part (the light-introducing surface) and the laser light source are arranged adjacent to each other, a projector-type vehicle light can be constructed which has a shorter dimension in an optical axis direction than conventional vehicle lights.

According to the sixth aspect of the present invention, since a laser light source device with a higher luminance than an LED, a tungsten halogen lamp, or an HID lamp is used, a vehicle light can be constructed which is capable of realizing a brighter light distribution (a high-beam light distribution pattern) than in a case where an LED, a tungsten halogen lamp, or an HID lamp is used.

According to a seventh aspect of the present invention, in any of the vehicle lights described above, the phosphor is arranged in the light-emitting region on the outer circumferential surface, the light-emitting region being enclosed by the first plane and the second plane which is inclined by 180 degrees or 360 degrees with respect to the first plane.

According to the seventh aspect of the present invention, by arranging the phosphor in an 180-degree light-emitting region, a laser light source device can be constructed which is capable of radiating light in a hemispherical direction in the same manner as an LED but which has a higher luminance than an LED. Consequently, a vehicle light can be constructed which is capable of realizing a brighter light distribution than in a case of using an LED.

In addition, by arranging the phosphor in a 360-degree light-emitting region, a laser light source device can be constructed which is capable of radiating light in all directions in the same manner as a tungsten halogen lamp or an HID lamp but which has a higher luminance than a tungsten halogen lamp or an HID lamp. Consequently, a vehicle light can be constructed which is capable of realizing a brighter light distribution than in a case of using a tungsten halogen lamp or an HID lamp.

According to an eighth aspect of the present invention, in the vehicle light according to any of the first to fourth aspects of the present invention, the optical system is a parabolic reflection surface arranged above a vehicle light optical axis, the laser light source device is arranged so that an optical axis thereof coincides with the vehicle light optical axis, and a focal point of the parabolic reflection surface is set in a vicinity of a rear end portion of the light-guiding part.

According to the eighth aspect of the present invention, since a compact laser light source device is used in which the light-guiding part (the light-introducing surface) and the laser light source are arranged adjacent to each other, a reflector-type vehicle light can be constructed which has a shorter dimension in an optical axis direction than conventional vehicle lights.

According to the eighth aspect of the present invention, since a laser light source device with a higher luminance than an LED, a tungsten halogen lamp, or an HID lamp is used, a vehicle light can be constructed which is capable of realizing a brighter light distribution than in a case where an LED, a tungsten halogen lamp, or an HID lamp is used.

According to a ninth aspect of the present invention, in the vehicle light according to any of the first to fourth features of the present invention, the optical system is a parabolic reflection surface arranged below a vehicle light optical axis, the laser light source device is arranged so that an optical axis thereof coincides with the vehicle light optical axis, and a focal point of the parabolic reflection surface is set in a vicinity of a front end portion of the light-guiding part.

According to the ninth aspect of the present invention, since a compact laser light source device is used in which the light-guiding part (the light-introducing surface) and the laser light source are arranged adjacent to each other, a reflector-type vehicle light can be constructed which has a shorter dimension in an optical axis direction than conventional vehicle lights.

According to the ninth aspect of the present invention, since a laser light source device with a higher luminance than an LED, a tungsten halogen lamp, or an HID lamp is used, a vehicle light can be constructed which is capable of realizing a brighter light distribution than in a case where an LED, a tungsten halogen lamp, or an HID lamp is used.

According to a tenth aspect of the present invention, in the vehicle light according to the eighth aspect of the present invention, the phosphor is arranged in the light-emitting region on the outer circumferential surface, the light-emitting region being enclosed by the first plane and the second plane which is inclined by 180 degrees, 195 degrees, or 360 degrees with respect to the first plane.

According to the tenth aspect of the present invention, by arranging the phosphor in a 180-degree light-emitting region, a light distribution pattern including a horizontal cutoff can be formed. In addition, by arranging the phosphor in a 360-degree light-emitting region, an approximately circular light distribution pattern can be formed. Furthermore, by arranging the phosphor in a 195-degree light-emitting region, a low-beam light distribution pattern including a horizontal cutoff and a diagonal cutoff can be formed.

According to an eleventh aspect of the present invention, in any of the vehicle lights described above, the phosphor is arranged in the light-emitting region on the outer circumferential surface, the light-emitting region being enclosed by the first plane and the second plane which is inclined by 360 degrees with respect to the first plane, and the vehicle light further comprises a reflection surface arranged around the outer circumferential surface of the light-guiding part at an interval from the outer circumferential surface.

According to the eleventh aspect of the present invention, due to the action of the reflection surface arranged at an interval from the outer circumferential surface, the luminous flux radiated by the laser light source device can be almost doubled.

According to a twelfth aspect of the present invention, in the vehicle light according to the eighth aspect of the present invention, the phosphor is arranged in the light-emitting region on the outer circumferential surface, the light-emitting region being enclosed by the first plane and the second plane which is inclined by 360 degrees with respect to the first plane, the vehicle light further comprises: a reflection surface arranged around the outer circumferential surface of the light-guiding part at an interval from the outer circumferential surface; and a heat sink stand on which the light-guiding part and the laser light source are arranged adjacent to each other and which is formed with a reflection surface arranged around the outer circumferential surface of the light-guiding part, and the heat sink stand includes a horizontal surface cut by a third plane including the cylindrical axis of the light-guiding part and a diagonal surface cut by a fourth plane including the cylindrical axis of the light-guiding part and inclined by 195 degrees with respect to the third plane.

According to the twelfth aspect of the present invention, a low-beam light distribution pattern including a horizontal cutoff and a diagonal cutoff can be formed.

According to a thirteenth aspect of the present invention, in the vehicle light any of the first to eleventh features of the present invention, the vehicle light further comprises a heat sink stand on which the light-guiding part and the laser light source are arranged adjacent to each other.

According to the thirteenth aspect of the present invention, since the phosphor and the laser light source can be constructed as a part arranged on the heat sink stand, a laser light source device can be constructed in which the phosphor and the laser light source are aligned with high accuracy without any displacement.

According to a fourteenth aspect of the present invention, in the vehicle light according to the twelfth or thirteenth aspect of the present invention, the vehicle light further comprises a heat sink substrate that includes a slide-in structure to which the heat sink stand is detachably mounted.

According to the fourteenth aspect of the present invention, heat generated by the phosphor or the like can be transferred from the heat sink stand to the side of a vehicle light chassis by thermal conduction. In addition, when mounting the laser light source device, the laser light source device can be accurately positioned with respect to the optical system. Furthermore, even in the event of a malfunction of the laser light source device, the laser light source device can be easily replaced.

According to a fifteenth aspect of the present invention, in any of the vehicle lights described above, the light-guiding part has an outer diameter of 0.3 to 2 mm and a length of 0.3 to 6 mm.

According to the fifteenth aspect of the present invention, a high-luminance light-emitting part can be constructed which is even smaller than a high-luminance light-emitting part (a filament of a tungsten halogen lamp, an arc tube of an HID lamp, or the like) required as a headlight.

According to the present invention, a vehicle light which uses a laser light source device and which has a shorter dimension in an optical axis direction than conventional vehicle lights can be provided.

### BRIEF DESCRIPTION OF THE DRAWINGS

FIG. 1 is a longitudinal sectional view of a conventional vehicle light 200;

FIG. 2 is a transverse sectional view of the conventional vehicle light 200;

FIG. 3 is a table for explaining a relationship among luminances of a laser light source, an LED, and an HID;

FIG. 4 is a perspective view showing a construction of a light source device according to a first embodiment of the present invention;

FIGS. 5A and 5B are, respectively, a perspective view and a top view showing a construction of a wavelength converting structure according to the first embodiment of the present invention;

FIGS. 6A and 6B are, respectively, sectional views taken along line 6a-6a and line 6b-6b in FIG. 5B;

FIG. 7 is a sectional view for illustrating operations of the light source device according to the first embodiment of the present invention;

FIG. 8 is a sectional view of the wavelength converting structure according to the first embodiment of the present invention;

FIGS. 9A to 9D are sectional views showing a manufacturing process of the wavelength converting structure according to the first embodiment of the present invention;

FIGS. 10A and 10B are sectional views showing a construction of a wavelength converting structure according to a second embodiment of the present invention;

FIG. 11A is a perspective view showing a construction of a wavelength converting structure according to a third embodiment of the present invention, and FIG. 11B is a sectional view showing a construction of a light source device according to the third embodiment of the present invention;

FIG. 12 is a longitudinal sectional view for illustrating operations of a light source device according to a fourth embodiment of the present invention;

FIG. 13 is a longitudinal sectional view of a vehicle light 70;

FIG. 14A is a perspective view of a slide-in structure (before mounting a laser light source device), and FIG. 14B is a perspective view of the slide-in structure (after mounting the laser light source device);

FIG. 15 is a perspective view of a vehicle light 80;

FIG. 16 is a longitudinal sectional view of a vehicle light 90;

FIG. 17 is a sectional view of a wavelength converting structure 20 (with a phosphor-containing resin 24 having an application area θ1=195 degrees) cut along a plane perpendicular to a cylindrical axis AXc;

FIG. 18A is a front view of a vehicle light 90 (with a phosphor-containing resin 24 having an application area θ1=195 degrees), and FIG. 18B shows an example of a light distribution pattern formed by the vehicle light 90 shown in FIG. 18A;

FIG. 19A is a front view of a modification of the vehicle light 90 (with a phosphor-containing resin 24 having an application area θ1=180 degrees), and FIG. 19B shows an example of a light distribution pattern formed by the modification of the vehicle light 90 shown in FIG. 19A;

FIG. 20A is a front view of a modification of the vehicle light 90 (with a phosphor-containing resin 24 having an application area θ1=360 degrees), and FIG. 20B shows an example of a light distribution pattern formed by the modification of the vehicle light 90 shown in FIG. 20A;

FIG. 21 is a sectional view of a modification of a laser light source device 4 cut along a plane perpendicular to a cylindrical axis AXc; and

FIG. 22A is a front view of a vehicle light constructed using the laser light source device 4 (modification) shown in FIG. 21, and FIG. 22B shows an example of a light distribution pattern formed by the vehicle light shown in FIG. 22A.

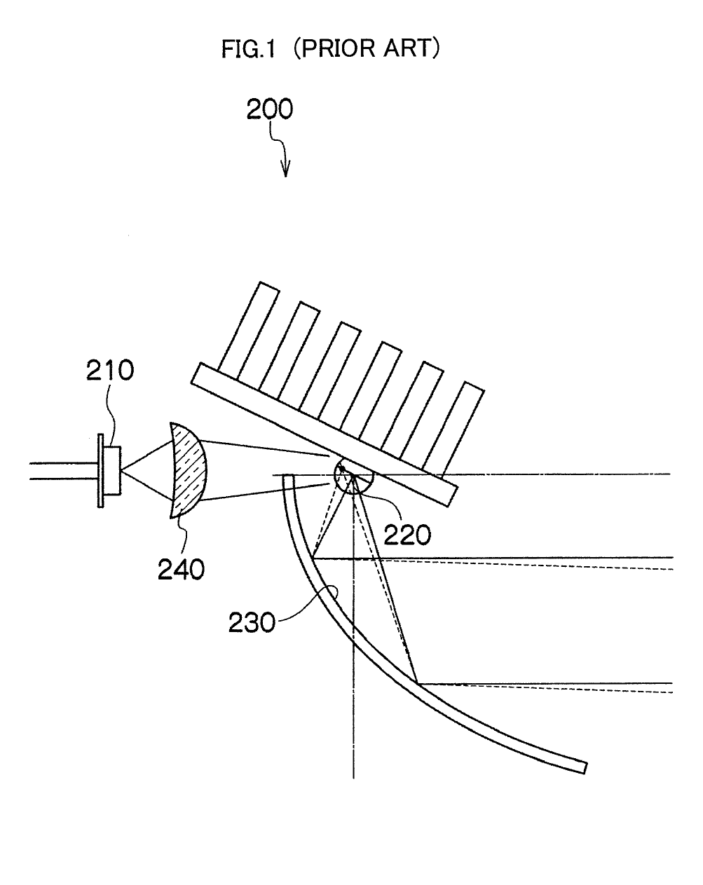

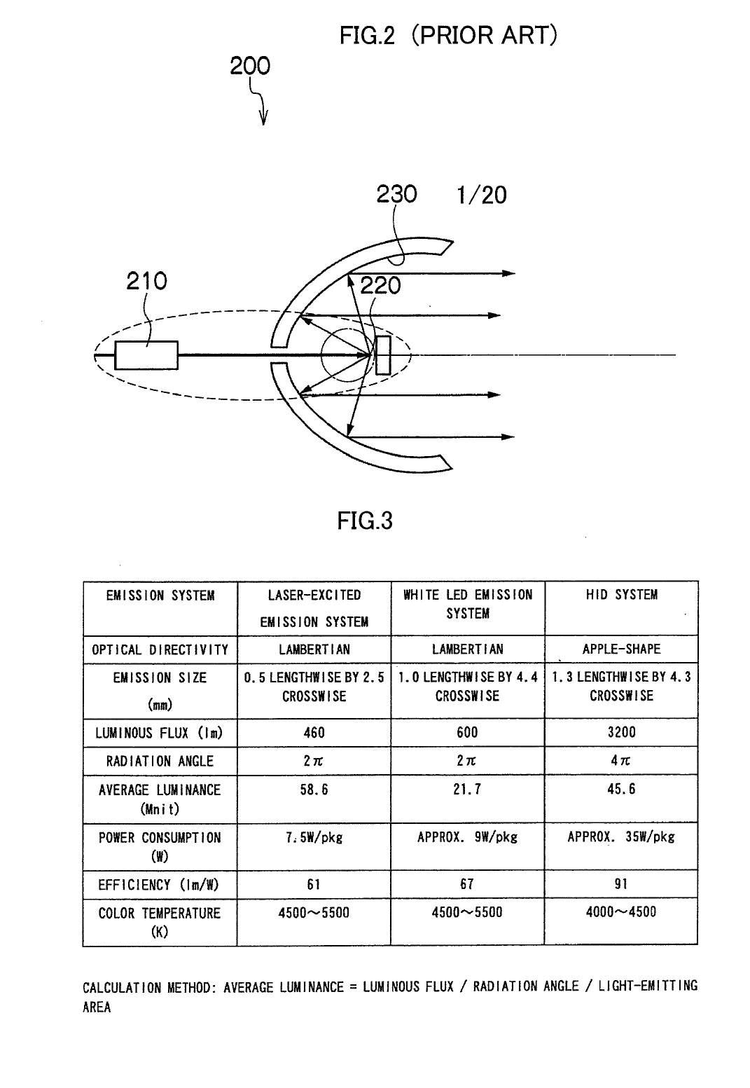

### DETAILED DESCRIPTION OF THE INVENTION

Hereinafter, a laser light source device 1 according to a first embodiment of the present invention will be described.

### First Embodiment

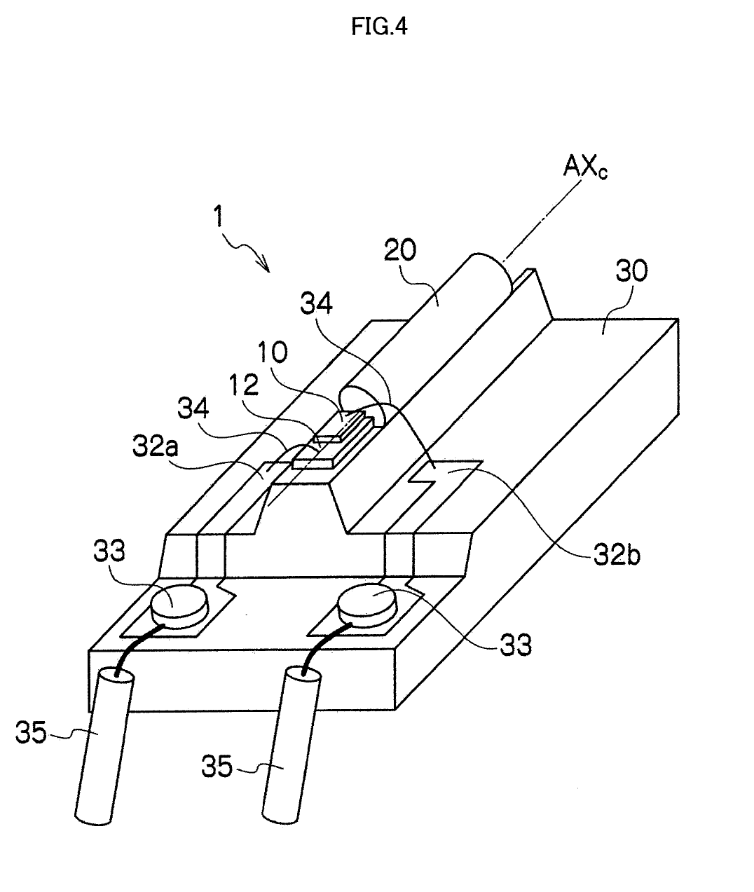

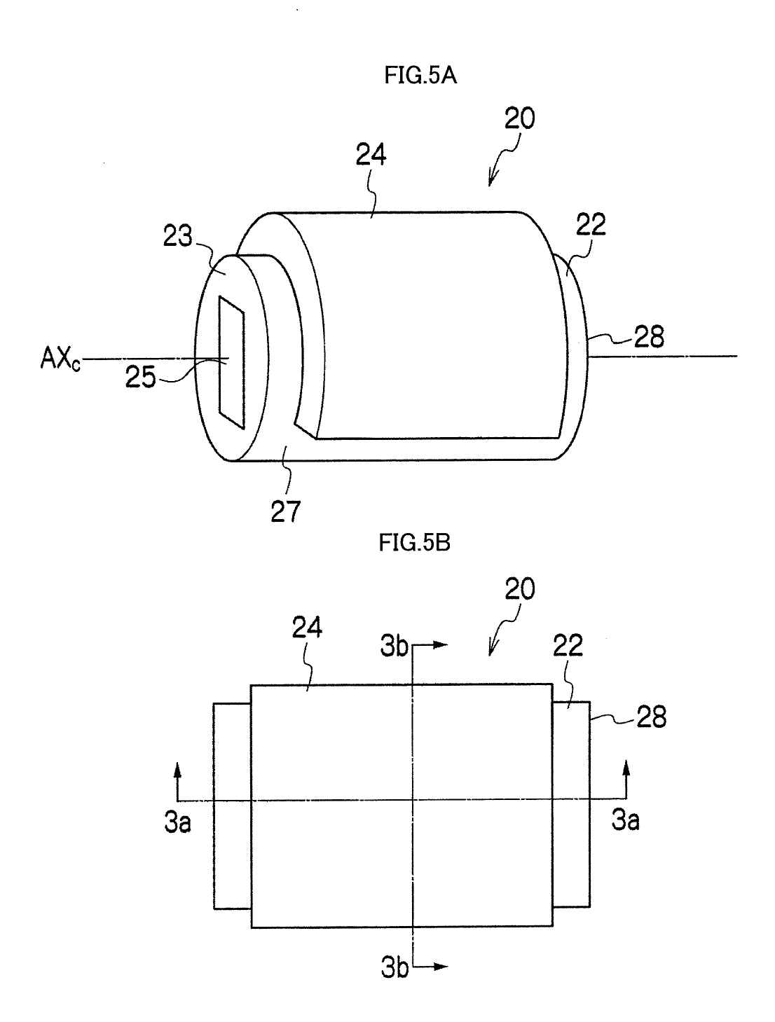

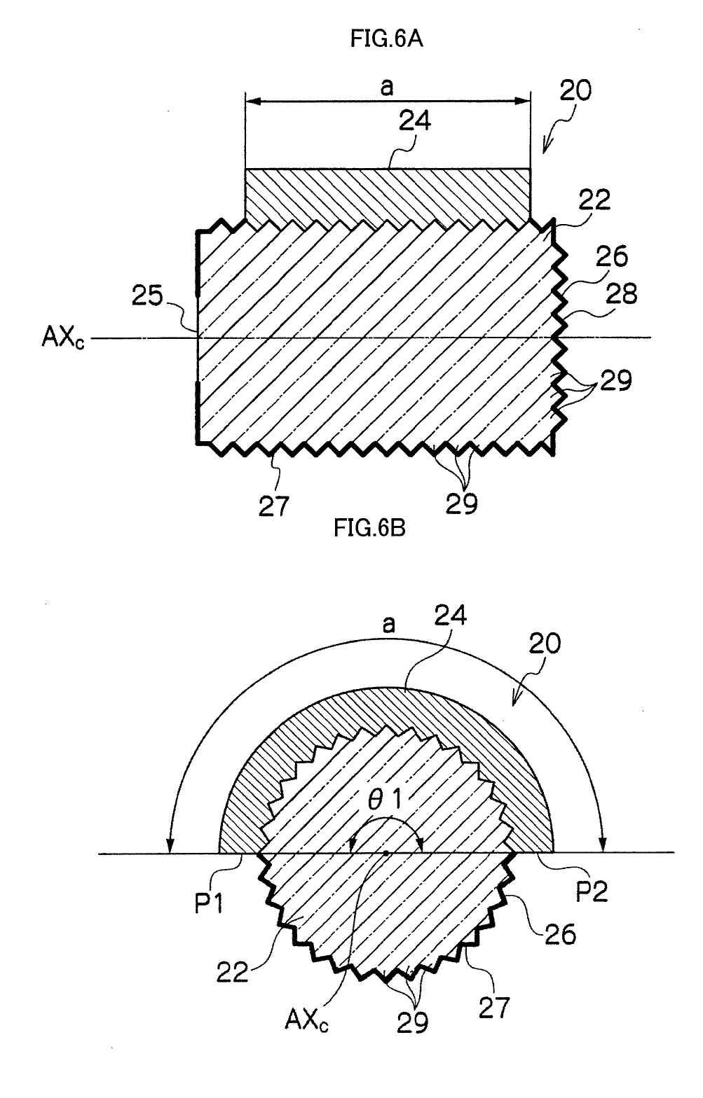

FIG. 4 is a perspective view showing a construction of the laser light source device 1 according to the first embodiment of the present invention, and FIGS. 5A and 5B are, respectively, a perspective view and a top view showing a construction of a wavelength converting structure 20 comprising the light source device 1. FIGS. 6A and 6B are, respectively, sectional views taken along line 6a-6a and line 6b-6b in FIG. 5B.

A laser diode 10 as a laser light source is a semiconductor laser which, for example, includes a nitride-based semiconductor layer such as GaN and which radiates a blue light with a wavelength of around 450 nm. The laser diode 10 is mounted on a submount 12 made of ceramics or the like. The submount 12 on which the laser diode 10 is mounted is, in turn, mounted on an upper surface of a heat sink stand 30. A conductor wiring (not shown) that is electrically connected to a back electrode of the laser diode 10 is formed on a surface of the submount 12. The conductor wiring and a first electrode 32a provided on the heat sink stand 30 are electrically connected to each other by a bonding wire 34. A surface electrode of the laser diode 10 and a second electrode 32b provided on the heat sink stand 30 are also electrically connected to each other by the bonding wire 34. The first electrode 32a and the second electrode 32b respectively correspond to a p-electrode and an n-electrode of the laser diode 10. A fixing support 33 for fixing a lead wire 35 is provided at terminations of the first electrode 32a and the second electrode 32b. The lead wire 35 is a wiring for supplying power to the laser diode 10. The heat sink stand 30 is made of Cu, Al, or the like which has high thermal conductivity. The first electrode 32a and the second electrode 32b are provided on the heat sink stand 30 via an insulating film.

The wavelength converting structure 20 is provided adjacent to the laser diode 10 (refer to FIG. 4). As shown in FIGS. 5A and 5B, the wavelength converting structure 20 comprises a light-guiding part 22 made of a light-transmissive cylindrical glass material and a phosphor-containing resin 24 arranged (applied) on an outer circumferential surface 27 of the light-guiding part 22. The phosphor-containing resin 24 constitutes a light-extracting surface which converts a waveform of a laser beam introduced into the light-guiding part 22 and radiates the waveform-converted laser beam to the outside.

The light-guiding part 22 has a surface comprising one end surface 23 (hereinafter also referred to as a laser incident end surface 23) including a light-introducing surface 25 (hereinafter also referred to as a laser incident port 25) that introduces a laser beam into the light-guiding part 22, an outer circumferential surface 27, and another end surface 28.

The wavelength converting structure 20 is arranged so that the laser incident end surface 23 having the laser incident port 25 opposes a laser exit surface of the laser diode 10 (refer to FIG. 4). In other words, the wavelength converting structure 20 is arranged so that a cylindrical axis AXc of the light-guiding part 22 and a direction of an optical axis of the laser beam coincide with each other.

As shown in FIGS. 6A and 6B, a plurality of minute irregularities 29 as a diffusing surface are set in regions (such as the outer circumferential surface 27 and the other end surface 28) on the surface of the light-guiding part 22 other than the light-introducing surface 25. For example, the irregularities 29 are formed by a random roughening process such as a blast process or the like. Moreover, the irregularities 29 may have a regular shape such as a conical shape or a pyramidal shape formed using a photolithographic technique. The irregularities 29 have a depth of 100 nm or greater and 5 μm or less or, more favorably, a depth of 500 nm that is similar to a laser wavelength. Each of the protrusions constituting the irregularities 29 of the surface of the light-guiding part 22 favorably has a size smaller than ten times the laser wavelength and an aspect ratio of 0.5 or greater.

The surface of the light-guiding part 22 is covered by a light-reflecting film 26 with the exception of a portion that forms the laser incident port 25 and a portion that forms the phosphor-containing resin 24. The light-reflecting film 26 is made of a material having a high reflectance and a high thermal conductivity such as Ag, Al, or other metals, or a Ba-oxide. The light-reflecting film 26 is formed along the irregularities 29 on the surface of the light-guiding part 22. As a result, a light-reflecting surface conforming to the diffusing surface (the irregularities 29) is formed. At a central part of the laser incident end surface 23, the light-guiding part 22 has a laser incident port 25 which is not covered by the light-reflecting film 26 and at which the glass material is exposed. A laser beam outputted from the laser diode 10 is introduced into the light-guiding part 22 via the laser incident port 25. A position, a shape, and dimensions of the laser incident port 25 can be set as appropriate in consideration of a spot size of the laser beam, relative positions of the laser diode 10 and the light-guiding part 22, and the like.

The light-reflecting film 26 forms a light-reflecting surface at an interface with the light-guiding part 22 and prevents a laser beam introduced into the light-guiding part 22 from being radiated to the outside from a portion other than the surface of the phosphor-containing resin 24. In other words, a laser beam introduced into the light-guiding part 22 is radiated to the outside only via the interior of the phosphor-containing resin 24. A light diffusing structure is formed on the surface of the light-guiding part 22 by a combination of the diffusing surface (the irregularities 29) formed on the surface of the light-guiding part 22 and the light-reflecting film 26.

The phosphor-containing resin 24 is produced by dispersing a YAG:Ce phosphor into a light-transmissive resin such as a silicone resin. For example, the phosphor absorbs a blue light with a wavelength of around 450 nm that is outputted from the laser diode 10 into a yellow light having a luminescence peak at a wavelength of around 560 nm. The yellow light waveform-converted by the phosphor and blue light which is transmitted through the phosphor-containing resin 24 without being waveform-converted mix together to produce a white light from the surface of the phosphor-containing resin 24. The phosphor has a particle diameter of 10 μm or less or, more favorably, 5 μm or less.

The phosphor-containing resin 24 is formed so as to conform to a curved shape of the outer circumferential surface 27 of the light-guiding part 22. As shown in FIGS. 6A and 6B, on the outer circumferential surface 27 of the light-guiding part 22, the phosphor-containing resin 24 is arranged (applied) in a region a (hereinafter also referred to as a light-emitting region a) enclosed by a first plane P1 (a horizontal plane) including a cylindrical axis AXc of the light-guiding part 22 and a second plane P2 which includes the cylindrical axis AXc of the light-guiding part 22 and which is inclined by θ1=180 degrees with respect to the first plane P1. In other words, approximately half of the outer circumferential surface 27 of the light-guiding part 22 in a circumferential direction is covered by the phosphor-containing resin 24, and a while light is radiated in this range. For example, the phosphor-containing resin 24 has a thickness of around 100 μm.

Next, a description of operations of the laser light source device 1 constructed as described above will be given.

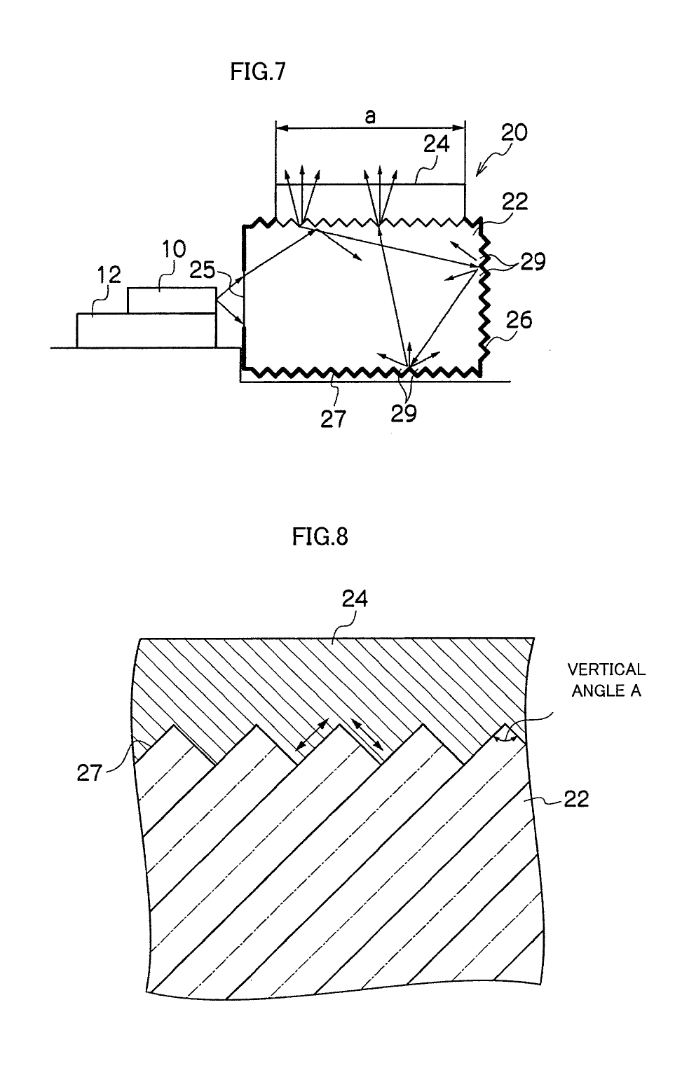

When power is supplied to the laser diode 10 via a pair of lead wires 35, as shown in FIG. 7, a blue laser beam with a wavelength of around 450 nm is outputted from the laser exit surface of the laser diode 10. The laser beam is introduced into the light-guiding part 22 via the laser incident port 25.

The laser beam introduced into the light-guiding part 22 is diffused in random directions by the light diffusing structure constituted by the diffusing surface (the irregularities 29) of the light-guiding part 22 and the light-reflecting film 26, and is outputted as a diffused light from the light-emitting region a which is not covered by the light-reflecting film 26 among the outer circumferential surface 27 and enters the phosphor-containing resin 24. Due to the light-guiding part 22 having the light diffusing structure, the number of reflections of the laser beam inside the light-guiding part 22 can be reduced and high efficiency is realized. In addition, since the laser beam is diffused inside the light-guiding part 22 in random directions by the light diffusing structure, the laser beam can be made incident to an entire surface of the phosphor-containing resin 24. In other words, since light can be extracted from the entire surface of the phosphor-containing resin 24, the area of the light-emitting part can be expanded and the occurrence of uneven luminance can be prevented. In particular, by forming irregularities 29 with a part size smaller than ten times the laser wavelength and an aspect ratio of 0.5 or greater on the surface of the light-guiding part 22, the occurrence of uneven luminance can be prevented in an effective manner. Moreover, by adjusting the size and density of the irregularities 29, angles of inclination of the respective surfaces constituting the irregularities 29, and the like (for example, by varying the size and density of the irregularities 29, the angles of inclination of the respective surfaces constituting the irregularities 29, and the like for each portion), the occurrence of uneven luminance can be further prevented or reduced.

Hypothetically, if the diffusing surface (the irregularities 29) is not formed and the surface of the light-guiding part 22 is flat, a laser beam introduced into the light-guiding part 22 is attenuated as a result of being repetitively reflected inside the light-guiding part 22 and luminous efficiency decreases. In addition, in this case, the laser beam concentrates at a specific portion of the phosphor-containing resin 24 and the area of the light-emitting area decreases. Furthermore, it is highly probable that light reflected off of the flat surface creates interference waves and uneven luminance may occur on a light-extracting surface.

Since an exposed surface of the light-guiding part 22 is covered by the light-reflecting film 26 with the exception of the laser incident port 25 and the light-emitting region a, a laser beam introduced into the light-guiding part 22 is entirely introduced into the phosphor-containing resin 24. In other words, a laser beam introduced into the light-guiding part 22 via the laser incident port 25 exits the light-emitting region a as a diffused light and is radiated to the outside via the phosphor-containing resin 24.

A laser beam introduced into the phosphor-containing resin 24 collides with phosphor particles and undergoes diffraction to create a new wave surface. In other words, each phosphor particle can be regarded as a new light source. Light diffracted by the phosphor particles becomes an incoherent light which cannot be restored by any optical system to a spot diameter of the laser beam outputted from the laser diode 10. In other words, by traveling through the phosphor-containing resin 24, a beam spot size of the laser beam expands to a size of the phosphor-containing resin 24.

As described above, for example, the phosphor absorbs a blue light with a wavelength of around 450 nm that is outputted from the laser diode 10 into a yellow light having a luminescence peak at a wavelength of around 560 nm. Due to mixing of the yellow light waveform-converted by the phosphor and blue light which is transmitted through the phosphor-containing resin 24 without being waveform-converted, light radiated from the surface of the phosphor-containing resin 24 is perceived as white light. In other words, a blue laser beam outputted from the laser diode 10 is extracted as an incoherent white light from the entire surface of the phosphor-containing resin 24.

FIG. 8 shows an enlarged view of a vicinity of an interface between the light-guiding part 22 and the phosphor-containing resin 24. By forming irregularities similar to the irregularities 29 on the surface (the outer circumferential surface 27) of the light-guiding part 22, a surface area of the light-guiding part 22 increases and the adhesion between the light-guiding part 22 and the phosphor-containing resin 24 is enhanced.

Meanwhile, since the phosphor-containing resin 24 absorbs light energy and radiates heat when performing waveform conversion, the temperature of the phosphor-containing resin 24 varies significantly. Therefore, the phosphor-containing resin 24 repetitively expands and contracts due to temperature variation. Hypothetically, if the surface (the outer circumferential surface 27) of the light-guiding part 22 is flat, the phosphor-containing resin 24 becomes more susceptible to peeling due to a difference in thermal expansion coefficients between the light-guiding part 22 and the phosphor-containing resin 24. In other words, if the surface (the outer circumferential surface 27) of the light-guiding part 22 is flat, since thermal stresses created at an interface between the light-guiding part 22 and the phosphor-containing resin 24 acts in each portion in directions that cause the thermal stresses to strengthen each other, the light-guiding part 22 and the phosphor-containing resin 24 become vulnerable to thermal shock.

When irregularities are provided on the surface (the outer circumferential surface 27) of the light-guiding part 22 and the phosphor-containing resin 24 is formed so as to cover the irregularities as is the case with the present embodiment, thermal stresses created at the interface between the light-guiding part 22 and the phosphor-containing resin 24 acts in directions conforming to the irregularities as indicated by arrows in FIG. 8. In other words, thermal stresses do not act at each portion of the interface so as to interfere with each other and, as a result, peeling of the phosphor-containing resin 24 is less likely to occur. Particularly, when each of the plurality of protrusions constituting the irregularities has a regular shape such as a conical shape or a pyramidal shape and a vertical angle A of each protrusion is 90 degrees or less, thermal stress is completely separated at each portion of the interface and resistance to thermal shock can be significantly improved. In other words, due to the action of the irregularities having a vertical angle of 90 degrees or less, the adhesion between the light-guiding part 22 (the light-emitting region a) and the phosphor-containing resin 24 (phosphor) can be improved.

As shown, by forming irregularities on the surface (the light-emitting region a) of the light-guiding part 22 and forming the phosphor-containing resin 24 so as to cover the irregularities, both the adhesion between the light-guiding part 22 and the phosphor-containing resin 24 and resistance of the light-guiding part 22 and the phosphor-containing resin 24 to thermal shock, can be improved.

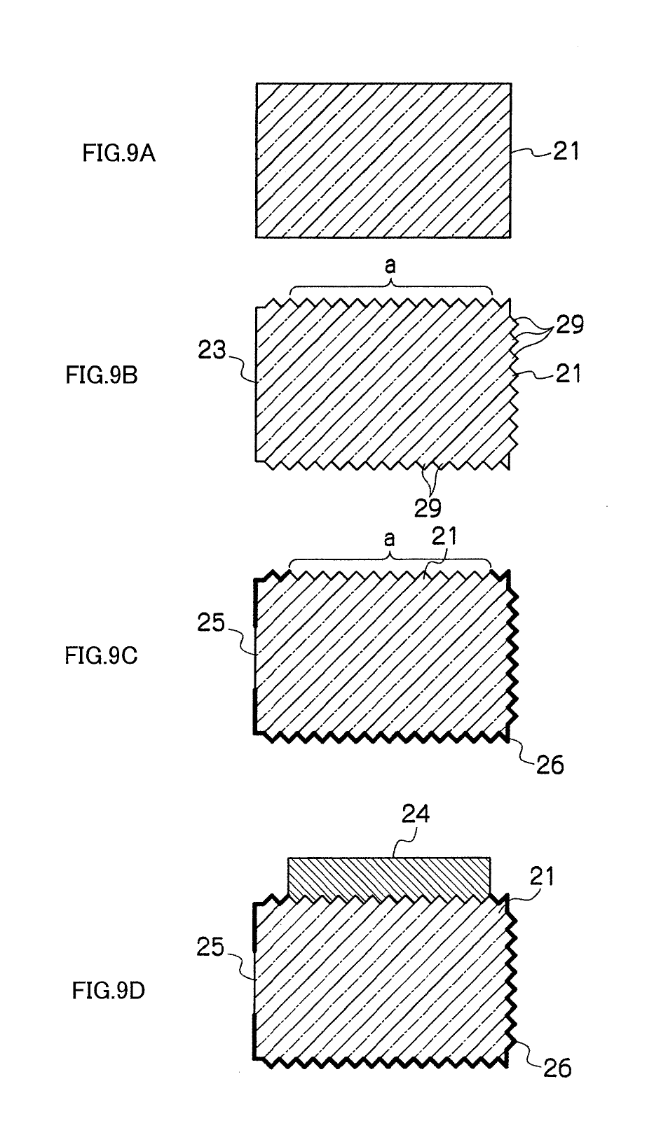

Next, a method of manufacturing the wavelength converting structure 20 according to an embodiment of the present invention will be described. FIGS. 9A to 9D are sectional views respectively showing each manufacturing process of the wavelength converting structure 20.

First, the glass material 21 that constitutes the light-guiding part 22 is prepared. The glass material 21 has a cylindrical shape with a diameter φ of 0.2 to 1.0 mm and a length l of 1.0 to 5.0 mm. For headlights, the glass material 21 desirably has a cylindrical shape with a diameter φ of 0.3 to 2.0 mm and a length l of 0.3 to 6.0 mm. Accordingly, a high-luminance light-emitting part can be constructed which is even smaller than a high-luminance light-emitting part (a filament of a tungsten halogen lamp, an arc tube of an HID lamp, or the like) required as a headlight.

Furthermore, for a low beam, the diameter φ and the length l desirably have a correlation ratio of φ:l=1:2 to 6, and for a high beam, a correlation ratio of φ:l=1:2 to 4. In addition, a narrower diameter φ is desirable in case of a low beam and a wider diameter φ is desirable in case of a high beam.

The glass material 21 is not limited to a cylindrical shape and may alternatively have a prismatic shape. In addition, the light-guiding part 22 may be constituted by a material other than a glass material such as a silicone resin, an epoxy resin, acryl, polycarbonate, or other light-transmissive resins. Furthermore, the light-guiding part 22 may be structured as a cylinder having a hollow interior (refer to FIG. 9A).

Next, the surface of the glass material 21 with the exception of the laser incident end surface 23 is subjected to a roughening process. Specifically, a mask that covers the laser incident end surface 23 of the glass material 21 is formed in advance, whereby the glass material 21 is bombarded by projectiles consisting of metal particles or ceramic particles to form randomly-shaped irregularities 29 on the surface of the glass material 21. In order to have the irregular surface effectively diffuse a laser beam, a depth of the irregularities 29 favorably approximately coincides with a wavelength of the laser beam. When using a blue laser, the irregularities 29 favorably have a depth of around 500 nm and an aspect ratio of 0.5 or higher. Moreover, the irregularities 29 may be formed using a known photolithographic technique so as to have a regular shape and arrangement (refer to FIG. 9B).

Next, after covering a portion that forms the laser incident port 25 and a portion (the light-emitting region a) that forms the phosphor-containing resin 24 with the mask, a metal film such as Ag and Al is deposited on the surface of the glass material 21. Accordingly, the light-reflecting film 26 and the laser incident port 25 are formed on the surface of the glass material 21. The light-reflecting film 26 is formed along the diffusing surface (the irregularities 29) on the surface of the glass material 21. Consequently, a light diffusing structure is formed. At the laser incident port formation portion and the phosphor-containing resin formation portion which are protected by the mask, the light-reflecting film 26 is not formed and the glass material 21 remains exposed.

Alternatively, the light-reflecting film 26 may be formed by selectively applying a Ba-oxide on the surface of the glass material 21 (refer to FIG. 9C).

Next, the phosphor-containing resin 24 in which a YAG:Ce phosphor is dispersed in a silicone resin is applied to the light-emitting region a in which the light-reflecting film 26 has not been formed among the surface (the outer circumferential surface 27) of the glass material 21. The phosphor-containing resin 24 is formed conforming to a curved shape of the outer circumferential surface 27 of the light-guiding part 22. Subsequently, heat treatment is performed to harden the phosphor-containing resin 24. Since the phosphor-containing resin 24 is formed on the irregularities of the surface of the glass material 21, adhesion between, the glass material 21 and the phosphor-containing resin 24 is secured (refer to FIG. 9D).

After the respective processes described above, the wavelength converting structure 20 is completed. The wavelength converting structure 20 is mounted to the heat sink stand 30 together with the laser diode 10 (refer to FIG. 4).

According to the present embodiment, as shown in FIG. 4, since the wavelength converting structure 20 and the laser diode 10 can be arranged adjacent to each other on the heat sink stand 30, the laser light source device 1 (for example, dimensions of the heat sink stand 30 are 20 mm crosswise by 30 to 40 mm lengthwise) can be constructed which is more compact than conventional laser light source devices.

In addition, according to the present embodiment, since the wavelength converting structure 20 (the phosphor-containing resin 24) and the laser diode 10 can be constructed as a part arranged on the heat sink stand 30, the laser light source device 1 can be constructed in which the wavelength converting structure 20 (the phosphor-containing resin 24) and the laser diode 10 are aligned with high accuracy without any displacement.

Furthermore, according to the present embodiment, since a construction is adopted in which a laser beam outputted by the laser diode 10 enters the phosphor-containing resin 24 as a diffused light that is diffused by the action of the diffusing surface (the irregularities 29), the laser light source device 1 can be constructed which is capable of radiating incoherent light having a light distribution similar to that of a tungsten halogen lamp or the like.

In addition, according to the present embodiment, due to the action of the diffusing surface (the irregularities 29), the laser light source device 1 can be constructed which is capable of securing a uniform luminance distribution and a uniform luminous color. Moreover, by adjusting the size and density of the irregularities 29, angles of inclination of the respective surfaces constituting the irregularities 29, and the like (for example, by varying the size and density of the irregularities 29, the angles of inclination of the respective surfaces constituting the irregularities 29, and the like for each portion), the laser light source device 1 can be constructed which is capable of further preventing or reducing the occurrence of uneven luminance. Accordingly, optical design for forming a light distribution pattern can be carried out with ease.

Furthermore, according to the present embodiment, since the light-guiding part 22 has a cylindrical shape (diameter d: 0.3 to 2.0 mm, length L: 0.3 to 6.0 mm), by adjusting a diameter φ and a length l thereof, a high-luminance light-emitting part can be constructed which is even smaller than a high-luminance light-emitting part (a filament of a tungsten halogen lamp, an arc tube of an HID lamp, or the like) required as a headlight. Accordingly, the laser light source device 1 can be constructed which is more compact than conventional laser light source devices. In addition, by adjusting an application area θ1 (the light-emitting region a) of the phosphor-containing resin 24, a shape of the light-emitting part can be freely selected.

Moreover, according to the present embodiment, by arranging (applying) the phosphor-containing resin 24 in a light-emitting region a where θ1=180 degrees (refer to FIG. 6B), the laser light source device 1 can be constructed which is capable of radiating light in a hemispherical direction in the same manner as an LED but which has a higher luminance than an LED. Consequently, a vehicle light can be constructed which is capable of realizing a brighter light distribution than in a case of using an LED.

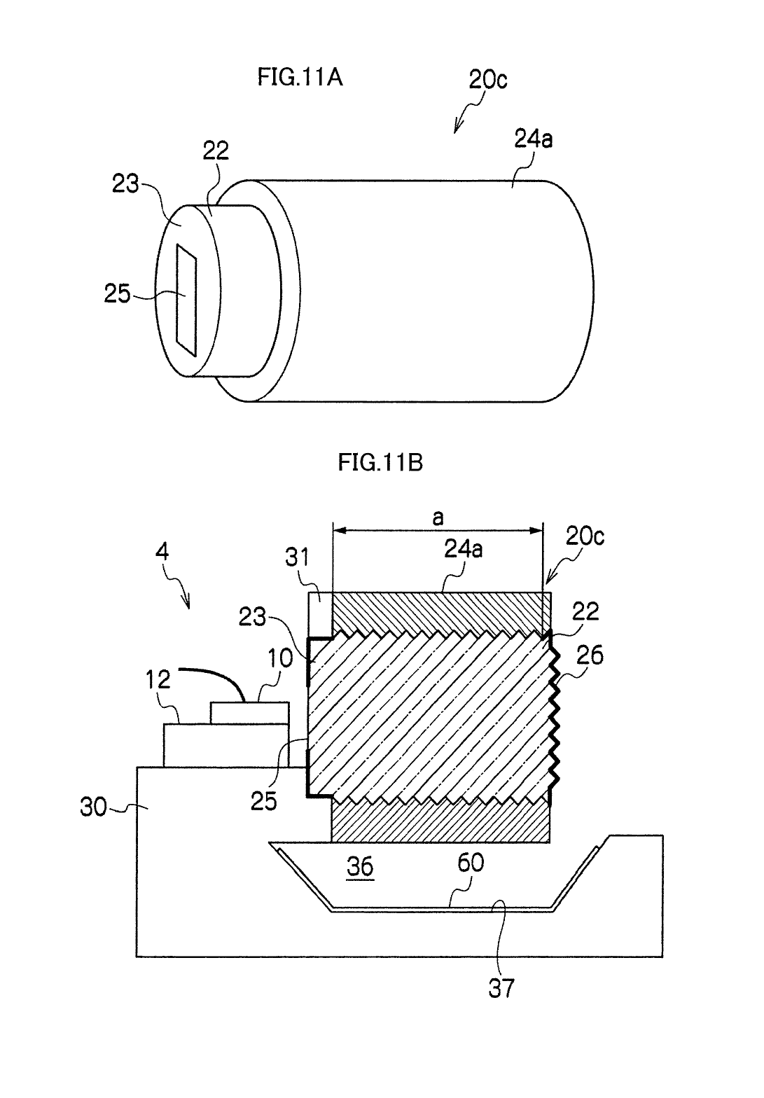

In addition, according to the present embodiment, by arranging (applying) the phosphor-containing resin 24 in a light-emitting region a where θ1=360 degrees (in other words, by applying the phosphor-containing resin 24 to the entire circumference of the outer circumferential surface 27 of the light-guiding part 22; refer to FIGS. 11A and 11B), the laser light source device 1 can be constructed which is capable of radiating light in all directions in the same manner as a tungsten halogen lamp or an HID lamp but which has a higher luminance than a tungsten halogen lamp or an HID lamp. Consequently, a vehicle light can be constructed which is capable of realizing a brighter light distribution than in a case of using a tungsten halogen lamp or an HID lamp.

As is apparent from the description above, with the light source device according to an embodiment of the present invention, a laser beam outputted from the laser diode 10 is introduced into the light-guiding part 22 and invariably travels through the phosphor-containing resin 24 before being radiated to the outside. In other words, a laser beam that is reflected off of the surface of the phosphor-containing resin 24 is never radiated to the outside as-is. A laser beam traveling through the phosphor-containing resin 24 is diffracted by phosphor particles and creates a new wave surface. In other words, each phosphor particle can be regarded as a new light source. Light diffracted by the phosphor particles becomes an incoherent light which cannot be restored by any optical system to a spot diameter of the laser beam outputted from the laser diode 10.

Furthermore, since the light diffusing structure constituted by the diffusing surface (the irregularities 29) and the light-reflecting film 26 is formed on the surface of the light-guiding part 22, a laser beam introduced into the light-guiding part 22 can be prevented from being repetitively reflected inside the light-guiding part 22 and a high luminous efficiency can be achieved. In addition, since a laser beam is diffused in random directions by the light diffusing structure, a laser beam introduced into the light-guiding part 22 can be extracted from the entire surface of the phosphor-containing resin 24. As a result, the area of the light-emitting part can be expanded and the occurrence of uneven luminance can be prevented.

Furthermore, since the phosphor-containing resin 24 is formed on the irregular surface of the light-guiding part 22, adhesion of the phosphor-containing resin 24 can be secured and resistance of the phosphor-containing resin 24 to thermal shock can be improved.

### Second Embodiment

Next, a laser light source device 2 according to a second embodiment of the present invention will be described.

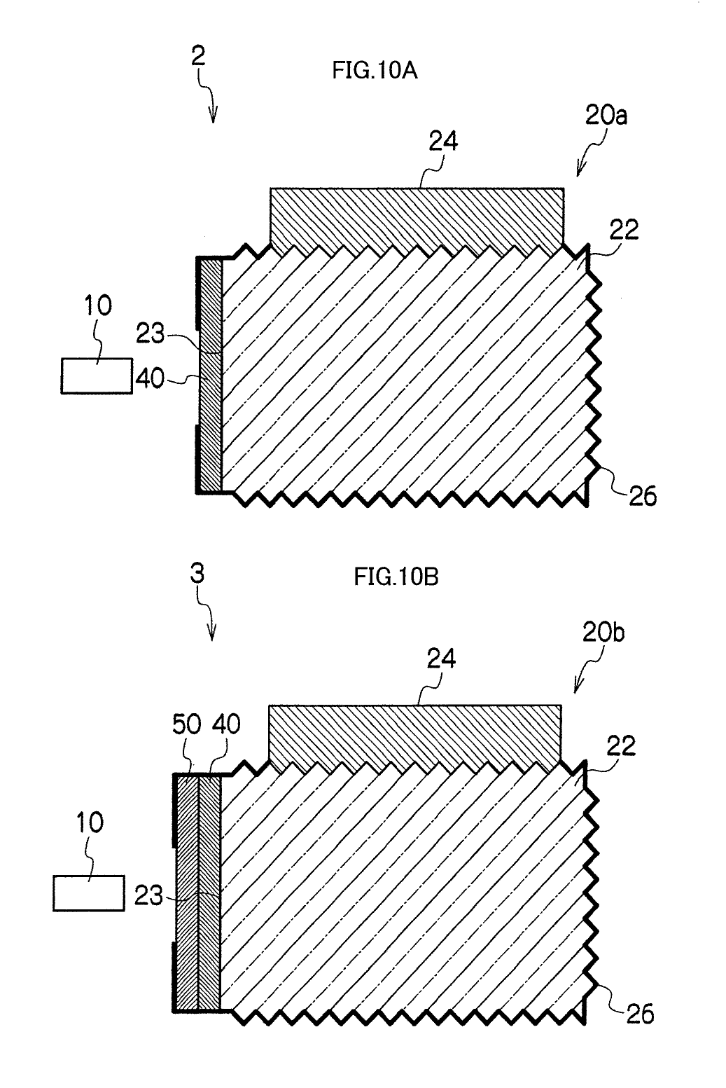

FIG. 10A is a sectional view showing a construction of a wavelength converting structure 20a according to the second embodiment of the present invention. The laser light source device 2 (the wavelength converting structure 20a) according to the present embodiment is similar to the wavelength converting structure 20 according to the first embodiment described above with the exception of a polarizing filter 40 for blocking returning light to a laser diode 10 being provided adjacent to a laser incident end surface 23 of a light-guiding part 22.

The polarizing filter 40 is a filter for transmitting a laser beam which is outputted from the laser diode 10 and introduced into the light-guiding part 22 from the laser incident end surface 23. As shown in FIG. 10A, the polarizing filter 40 is arranged between the laser diode 10 and the laser incident end surface 23. The polarizing filter 40 only transmits light that has an amplitude component oriented in a specific direction. The polarizing filter 40 is designed so as to transmit a linearly-polarized laser beam which is outputted from the laser diode 10 and which is directed toward the light-guiding part 22. A laser beam introduced into the light-guiding part 22 is diffused by a light diffusing structure formed on a surface of the light-guiding part 22. As a result, a vibration direction of the laser beam changes. Since the laser beam with the changed vibration direction is no longer able to pass through the polarizing filter 40, returning light to the laser diode 10 can be suppressed. When returning light enters the laser diode 10, laser oscillation becomes unstable and output fluctuation may occur. However, by attaching the polarizing filter 40 to the laser incident end surface 23 of the light-guiding part 22 to block returning light as in the present embodiment, an output stability of the laser diode 10 can be maintained.

As described above, according to the present embodiment, due to the action of the polarizing filter 40, an output fluctuation of the laser diode 10 attributable to a laser beam diffused inside the light-guiding part 22 being outputted from the laser incident end surface 23 and entering the laser diode 10 can be prevented.

### Third Embodiment

Next, a laser light source device 3 according to a third embodiment of the present invention will be described.

FIG. 10B is a sectional view showing a construction of a wavelength converting structure 20b with an improved returning light blocking function and improved transmittance of laser beams directed toward a light-guiding part 22. The laser light source device 3 (the wavelength converting structure 20b) according to the present embodiment is similar to the wavelength converting structure 20a according to the second embodiment described above with the exception of an antireflective film 50 provided adjacent to a polarizing filter 40.

As shown in FIG. 10B, the antireflective film 50 is arranged between a laser diode 10 and the polarizing filter 40. The antireflective film 50 is configured by alternately and repetitively laminating two types of layers with different refractive indexes. By setting a layer thickness of each layer in accordance with a wavelength of a laser beam, the antireflective film 50 acts such that reflected light created at respective interfaces between low refractive index layers and high refractive index layers cancel each other out while transmitted light directed toward the light-guiding part 22 strengthen each other. For example, the low refractive index layers are constituted by a SiO2 film and the high refractive index layers are constituted by a TiO2 film. Both of these films can be formed by vacuum deposition or sputter deposition. Moreover, instead of combining the antireflective film 50 with the polarizing filter 40, the antireflective film 50 can be used independently. In this case, the antireflective film 50 is provided adjacent to a laser incident end surface 23 of the light-guiding part 22.

As described above, according to the present embodiment, due to the action of the antireflective film 50, a transmitted light directed toward the light-guiding part 22 (the laser incident end surface 23) can be strengthened.

### Fourth Embodiment

Next, a laser light source device 4 according to a fourth embodiment of the present invention will be described.

FIG. 11A is a perspective view showing a construction of a wavelength converting structure 20c according to a fourth embodiment of the present invention, and FIG. 11B is a sectional view showing a construction of the light source device 4 according to the fourth embodiment of the present invention.

As shown in FIGS. 11A and 11B, the laser light source device 4 (the wavelength converting structure 20c) according to the present fourth embodiment is similar to the wavelength converting structures 20, 20a, and 20b according to the first to third embodiments described above with the exception of a phosphor-containing resin 24 being arranged (applied) to a light-emitting region a where θ1=360 degrees (in other words, the phosphor-containing resin 24 being applied to an entire circumference of an outer circumferential surface 27 of the light-guiding part 22), as well as a reflector 60 being provided.

As shown, the wavelength converting structure 20c according to the present embodiment is structured so as to be capable of emitting a white light in all directions along a circumferential direction of the outer circumferential surface 27 of the cylindrical light-guiding part 22.

As shown in FIG. 11B, the laser light source device 4 comprises: a heat sink stand 30; a laser diode 10 fixed onto a submount 12 arranged on a surface of the heat sink stand 30; a fixing ring 31 fixed onto the heat sink stand 30; the wavelength converting structure 20c which is fixed by inserting a side of a one end surface 23 into the fixing ring 31 and which is supported in a cantilevered manner in a state where a laser incident port 25 and the laser diode 10 are arranged adjacent to each other; a recess 36 formed in a region on an upper surface of the heat sink stand 30, the region being opposed by the wavelength converting structure 20c; a reflective film 37 formed on the recess 36; and the like. The reflective film 37 is arranged at an interval from the outer circumferential surface 27. The recess 36 is depressed so as to conform to an outer shape of the wavelength converting structure 20c.

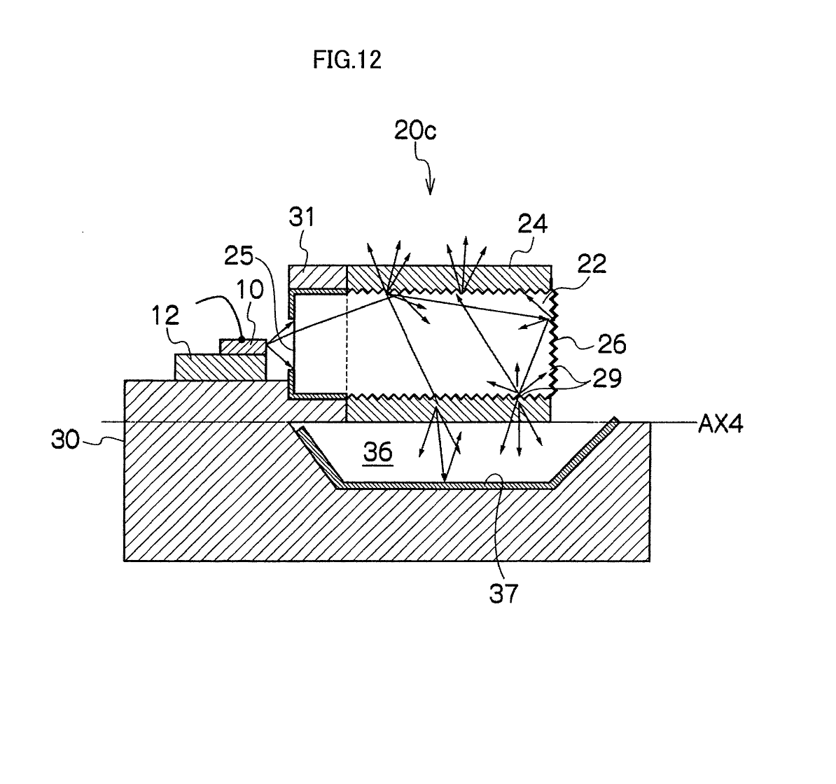

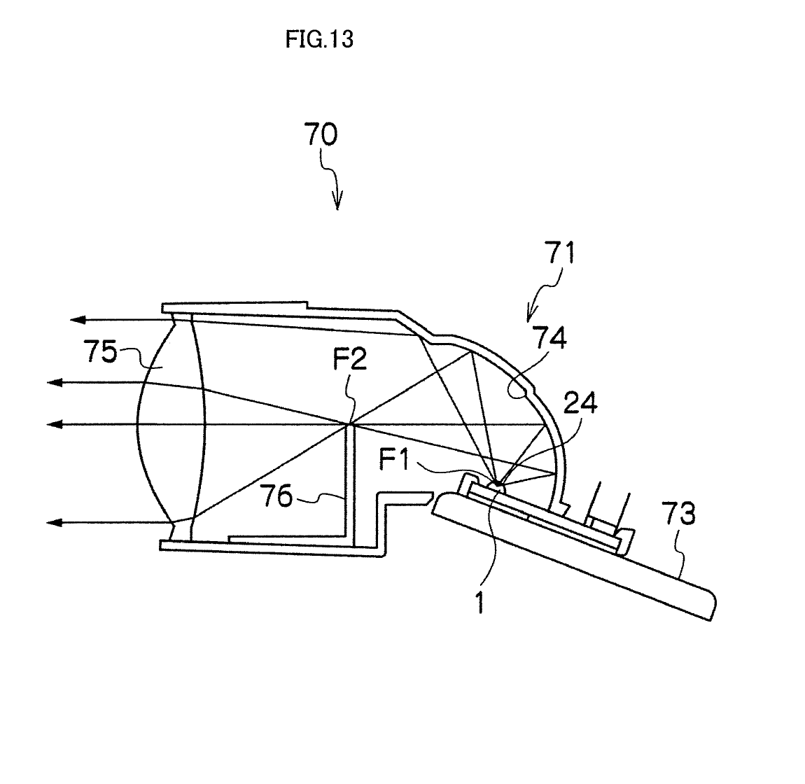

According to the present embodiment, due to the action of the reflective film 37, a luminous flux radiated by the laser light source device 4 can be almost doubled (refer to FIG. 12).

In addition, according to the present embodiment, advantages similar to those of the first embodiment can be achieved.

Moreover, while formation ranges of phosphor-containing resin have been described in a limited fashion in the respective embodiments above, the present invention is not limited to the formation ranges described above. The formation range of the phosphor-containing resin or, in other words, a range of the light-emitting part can be modified as appropriate in accordance with a light distribution design of the light source device.

Next, a projector-type vehicle light 70 constructed using the laser light source device 1 according to the first embodiment above will be described.

As shown in FIG. 13, the vehicle light 70 comprises: the laser light source device 1 (with the phosphor-containing resin 24 having an application area θ1=180 degrees); an optical system 71 configured so as to form a low-beam light distribution pattern using light radiated from the laser light source device 1; and the like.

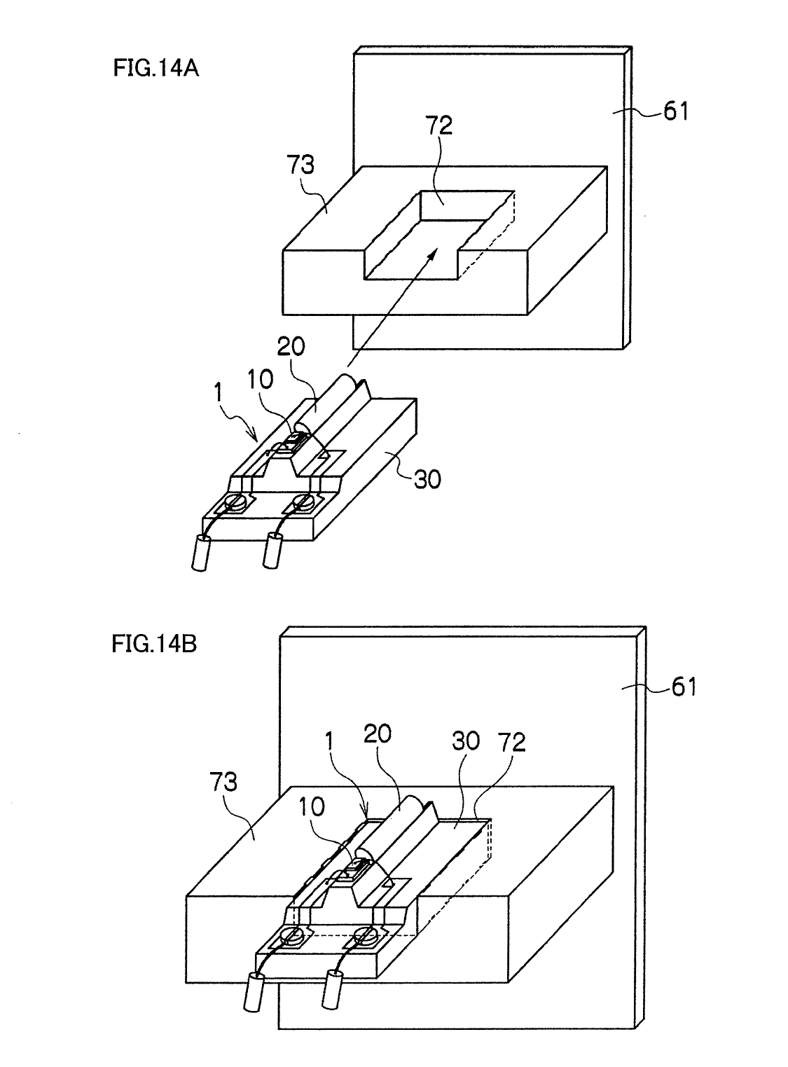

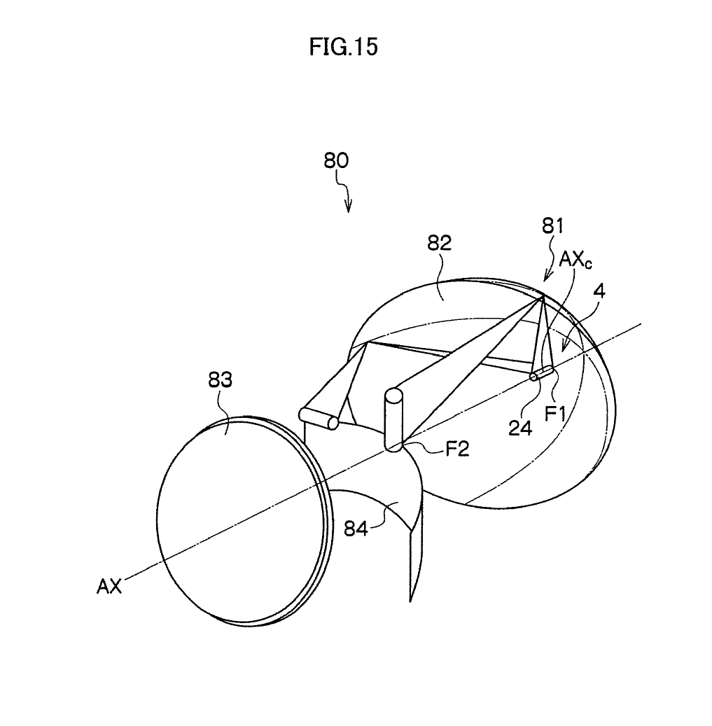

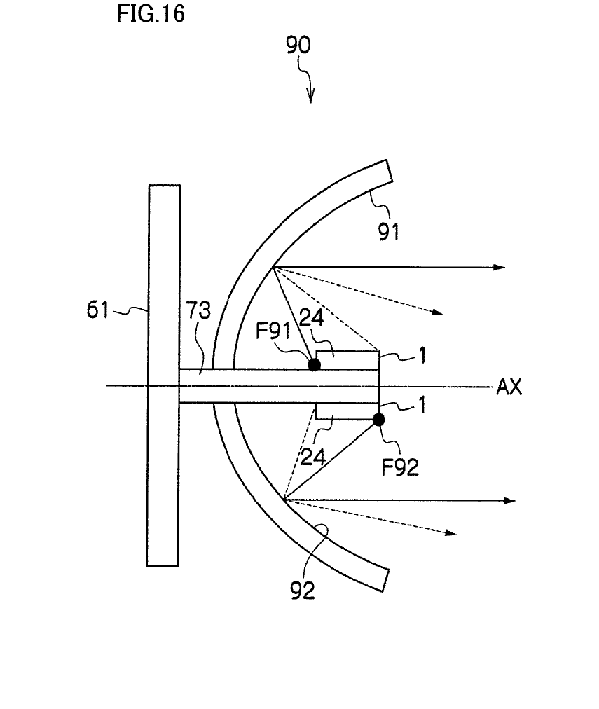

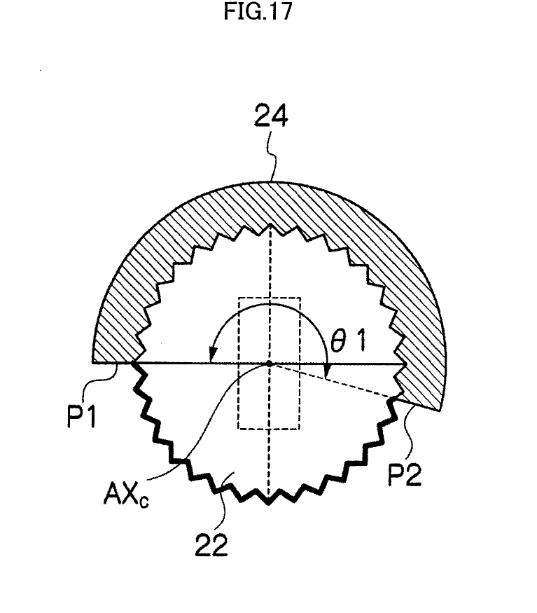

As shown in FIGS. 14A and 14B, the vehicle light 70 comprises a heat sink substrate 73 including a recess 72 (a slide-in structure) to which the laser light source device 1 is detachably mounted. Accordingly, heat generated by the wavelength converting structure 20 or the like can be transferred from the heat sink stand 30 to the side of a vehicle light chassis 61 by thermal conduction. In addition, when mounting the laser light source device 1, the laser light source device 1 can be accurately positioned with respect to the optical system 71. Furthermore, even in the event of a malfunction of the laser light source device 1, the laser light source device 1 can be easily replaced.

As shown in FIG. 13, the optical system 71 comprises: a reflection surface 74 which is arranged in front of the laser light source device 1 so that light radiated from the laser light source device 1 enters the reflection surface 74 and which reflects light incident from the laser light source device 1 as a converging beam that forms a low-beam light distribution pattern; a projection lens 75 that is arranged in front of the reflection surface 74 so that light reflected by the reflection surface 74 is transmitted through the projection lens 75; a shade 76 that is arranged between the reflection surface 74 and the projection lens 75 so as to block a part of the light reflected by the reflection surface 74 and form a cutoff of the low-beam light distribution pattern; and the like. For example, the reflection surface 74 is a spheroidal reflection surface having a first focal point F1 set in a vicinity of the phosphor-containing resin 24 and a second focal point F2 set in a vicinity of an upper edge of the shade 76.

According to the vehicle light 70 constructed as described above, as shown in FIG. 13, light radiated from the laser light source device 1 is reflected by the reflection surface 74, converges in the vicinity of the upper edge of the shade 76, passes through the projection lens 75, and is irradiated forward. As a result, a low-beam light distribution pattern including a cutoff defined by the upper edge of the shade 76 is formed on a virtual vertical screen that directly faces (arranged 25 m in front of) the projection lens 75.

In addition, according to the vehicle light 70 constructed as described above, since the compact laser light source device 1 is used in which the wavelength converting structure 20 (the laser incident end surface 23) and the laser diode 10 are arranged adjacent to each other on the heat sink stand 30, the projector-type vehicle light 70 can be constructed which has a shorter dimension in an optical axis direction than conventional vehicle lights.

Furthermore, according to the vehicle light 70 constructed as described above, since the laser light source device 1 with a higher luminance than an LED, a tungsten halogen lamp, or an HID lamp is used, a vehicle light can be constructed which is capable of realizing a brighter light distribution (a low-beam light distribution pattern) than in a case where an LED, a tungsten halogen lamp, or an HID lamp is used.

In addition, according to the vehicle light 70 constructed as described above, since the laser light source device 1 is used which is capable of securing a uniform luminance distribution and a uniform luminous color due to the action of the diffusing surface (the irregularities 29), a vehicle light can be constructed which is capable of realizing a light distribution (a low-beam light distribution pattern) with a uniform luminous color and without irregular color.

Moreover, the shade 76 may be omitted and the reflection surface 74 may be constructed such that light which is transmitted through the projection lens 75 and irradiated forward forms a high-beam light distribution pattern. Even with such a construction, advantages similar to those described above can be achieved.

While an example of constructing the vehicle light 70 using the laser light source device 1 (with the phosphor-containing resin 24 having an application area θ1=180 degrees) has been described above, the present invention is not limited to this construction. For example, the vehicle light 70 may be constructed using a laser light source device 1 (with the phosphor-containing resin 24 having an application area θ1=360 degrees). In addition, the vehicle light 70 may be constructed using the laser light source devices 2 to 4 instead of the laser light source device 1. Moreover, the application area θ1 (the light-emitting region a) of the phosphor-containing resin 24 can be adjusted as appropriate.

Next, a projector-type vehicle light 80 constructed using the laser light source device 4 according to the fourth embodiment above will be described.

As shown in FIG. 15, the vehicle light 80 comprises: the laser light source device 4 (with the phosphor-containing resin 24 having an application area θ1=360 degrees); an optical system 81 configured so as to form a low-beam light distribution pattern using light radiated from the laser light source device 4; and the like.

In the same manner as the vehicle light 70, the vehicle light 80 comprises a heat sink substrate 73 including a recess 72 (a slide-in structure) to which the laser light source device 4 is detachably mounted (refer to FIGS. 14A and 14B). Accordingly, heat generated by the wavelength converting structure 20c or the like can be transferred from the heat sink stand 30 to the side of a vehicle light chassis 61 by thermal conduction. In addition, when mounting the laser light source device 4, the laser light source device 4 can be accurately positioned with respect to the optical system 81. Furthermore, even in the event of a malfunction of the laser light source device 4, the laser light source device 4 can be easily replaced. Moreover, an optical axis AX4 (refer to FIG. 12) of the laser light source device 4 mounted to the heat sink substrate 73 coincides with a vehicle light optical axis AX (refer to FIG. 15).

As shown in FIG. 15, the optical system 81 comprises: a reflection surface 82 which is set so as to cover the laser light source device 4 so that light radiated from the laser light source device 4 enters the reflection surface 82 and which reflects light incident from the laser light source device 4 as a converging beam that forms a low-beam light distribution pattern; a projection lens 83 that is arranged in front of the reflection surface 82 so that light reflected by the reflection surface 82 is transmitted through the projection lens 83; a shade 84 that is arranged between the reflection surface 82 and the projection lens 83 so as to block a part of the light reflected by the reflection surface 82 and form a cutoff of the low-beam light distribution pattern; and the like. For example, the reflection surface 82 is a spheroidal reflection surface having a first focal point F1 set in a vicinity of the phosphor-containing resin 24 and a second focal point F2 set in a vicinity of an upper edge of the shade 84.

According to the vehicle light 80 constructed as described above, as shown in FIG. 15, light radiated from the laser light source device 4 is reflected by the reflection surface 82, converges in the vicinity of the upper edge of the shade 84, passes through the projection lens 83, and is irradiated forward. As a result, a low-beam light distribution pattern including a cutoff defined by the upper edge of the shade 84 is formed on a virtual vertical screen that directly faces the projection lens 83.

In addition, according to the vehicle light 80 constructed as described above, since the compact laser light source device 4 is used in which the wavelength converting structure 20c (the laser incident end surface 23) and the laser diode 10 are arranged adjacent to each other on the heat sink stand 30, the projector-type vehicle light 80 can be constructed which has a shorter dimension in an optical axis direction than conventional vehicle lights.

Furthermore, according to the vehicle light 80 constructed as described above, since the laser light source device 4 with a higher luminance than an LED, a tungsten halogen lamp, or an HID lamp is used, a vehicle light can be constructed which is capable of realizing a brighter light distribution (a low-beam light distribution pattern) than in a case where an LED, a tungsten halogen lamp, or an HID lamp is used.

In addition, according to the vehicle light 80 constructed as described above, since the laser light source device 4 is used which is capable of securing a uniform luminance distribution and a uniform luminous color due to the action of the diffusing surface (the irregularities 29), a vehicle light can be constructed which is capable of realizing a light distribution (a low-beam light distribution pattern) with a uniform luminous color and without irregular color.

Moreover, the shade 84 may be omitted and the reflection surface 82 may be constructed such that light which is transmitted through the projection lens 83 and irradiated forward forms a high-beam light distribution pattern. Consequently, a brighter high-beam light distribution pattern than in a case of using an LED, a tungsten halogen lamp, or an HID lamp can be realized.

While an example of constructing the vehicle light 80 using the laser light source device 4 (with the phosphor-containing resin 24 having an application area θ1=360 degrees) has been described above, the present invention is not limited to this construction. For example, the vehicle light 80 may be constructed using the laser light source device 4 (with the phosphor-containing resin 24 having an application area θ1=180 degrees). In addition, the vehicle light 80 may be constructed using the laser light source devices 1 to 3 instead of the laser light source device 4. Moreover, the application area θ1 (the light-emitting region a) of the phosphor-containing resin 24 can be adjusted as appropriate.

Next, a reflector-type vehicle light 90 constructed using the laser light source device 1 according to the first embodiment above will be described.

As shown in FIG. 16, the vehicle light 90 comprises: a laser light source device 1 arranged above a vehicle light optical axis AX; a laser light source device 1 arranged below the vehicle light optical axis AX; an upper reflection surface 91 configured so as to form a low-beam light distribution pattern using light radiated from the upper laser light source device 1; a lower reflection surface 92 configured so as to form a high-beam light distribution pattern using light radiated from the lower laser light source device 1; and the like.

For example, with the upper laser light source device 1, a phosphor-containing resin 24 has an application area θ1 of 195 degrees (refer to FIG. 17), and with the lower laser light source device 1, a phosphor-containing resin 24 has an application area θ1 of 180 degrees (refer to FIG. 6B).

In the same manner as the vehicle light 70, the vehicle light 90 comprises a heat sink substrate 73 including a recess 72 (a slide-in structure) to which the respective laser light source devices 1 are detachably mounted (refer to FIGS. 14A and 14B). Accordingly, heat generated by the wavelength converting structure 20 or the like can be transferred from the heat sink stand 30 to the side of a vehicle light chassis 61 by thermal conduction. In addition, when mounting the respective laser light source devices 1, the laser light source devices 1 can be accurately positioned with respect to the reflection surfaces 91 and 92. Furthermore, even in the event of a malfunction of the respective laser light source devices 1, the laser light source devices 1 can be easily replaced. Moreover, the optical axes of the respective laser light source devices 1 mounted to the heat sink substrate 73 coincide with the vehicle light optical axis AX.

As shown in FIG. 16, the upper reflection surface 91 is arranged in front of the upper laser light source device 1 so that light radiated from the upper laser light source device 1 enters the upper reflection surface 91. For example, the reflection surface 91 is a rotational parabolic reflection surface having a focal point F91 set in a vicinity of a rear end portion of the upper laser light source device 1 (the phosphor-containing resin 24).

In a similar manner, the lower reflection surface 92 is arranged in front of the lower laser light source device 1 so that light radiated from the lower laser light source device 1 enters the lower reflection surface 92. For example, the reflection surface 92 is a rotational parabolic reflection surface having a focal point F92 set in a vicinity of a front end portion of the lower laser light source device 1 (the phosphor-containing resin 24).

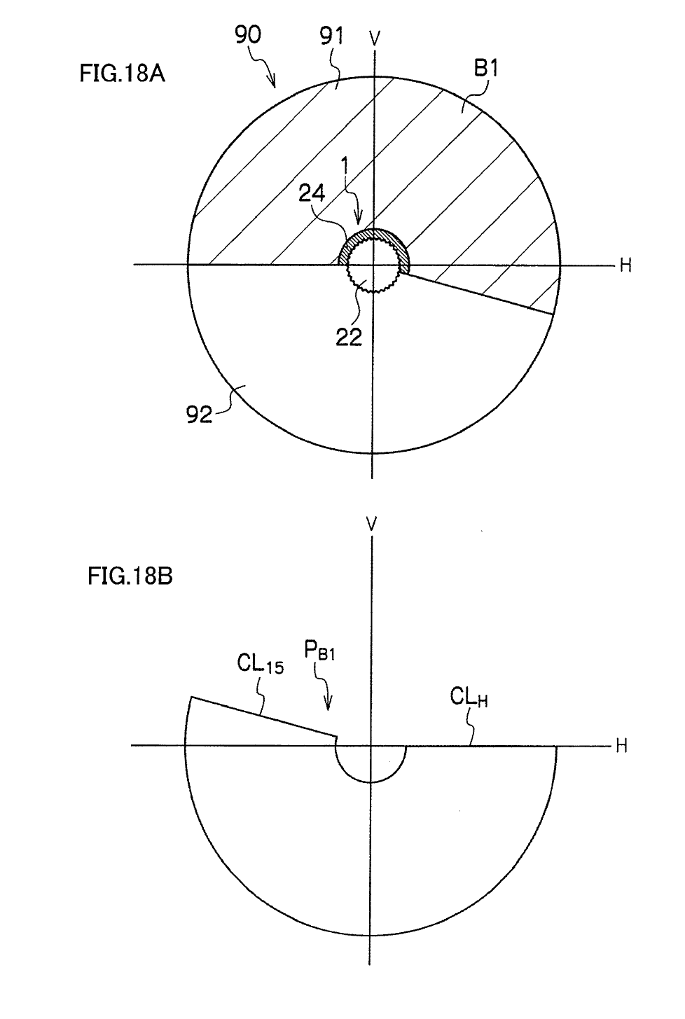

According to the vehicle light 90 constructed as described above, as shown in FIG. 18A, light radiated from the upper laser light source device 1 enters, and is reflected by, a region B1 (a region indicated by hatching in FIG. 18A) corresponding to the phosphor-containing resin 24 among the reflection surface 91 and the reflection surface 92, and is irradiated forward (an image of the region B1 is projected forward as a vertically and horizontally inverted image). As a result, as shown in FIG. 18B, a low-beam light distribution pattern P_{B1} having a horizontal cutoff CL_{H} and a 15-degree diagonal cutoff CL₁₅ is formed on a virtual vertical screen that directly faces the reflection surfaces 91 and 92.

In a similar manner, light radiated from the lower laser light source device 1 is reflected by the reflection surface 92 and is irradiated forward. Accordingly, a high-beam light distribution pattern is formed on the virtual vertical screen.

In addition, according to the vehicle light 90 constructed as described above, since the compact laser light source device 1 is used in which the wavelength converting structure 20 (the laser incident end surface 23) and the laser diode 10 are arranged adjacent to each other on the heat sink stand 30, the reflector-type vehicle light 90 can be constructed which has a shorter dimension in an optical axis direction than conventional vehicle lights.

Furthermore, according to the vehicle light 90 constructed as described above, since the laser light source device 1 with a higher luminance than an LED, a tungsten halogen lamp, or an HID lamp is used, a vehicle light can be constructed which is capable of realizing a brighter light distribution (a low-beam light distribution pattern and the like) than in a case where an LED, a tungsten halogen lamp, or an HID lamp is used.

In addition, according to the vehicle light 90 constructed as described above, since the laser light source device 1 is used which is capable of securing a uniform luminance distribution and a uniform luminous color due to the action of the diffusing surface (the irregularities 29), a vehicle light can be constructed which is capable of realizing a light distribution (a low-beam light distribution pattern and the like) with a uniform luminous color and without irregular color.

While an example of constructing the vehicle light 90 using the laser light source device 1 (with the phosphor-containing resin 24 having an application area θ1=195 degrees) as the upper laser light source device 1 has been described above, the present invention is not limited to this construction. For example, the vehicle light 90 may be constructed using a laser light source device 1 (with the phosphor-containing resin 24 having an application area θ1=180 degrees or 360 degrees) as the upper laser light source device 1.

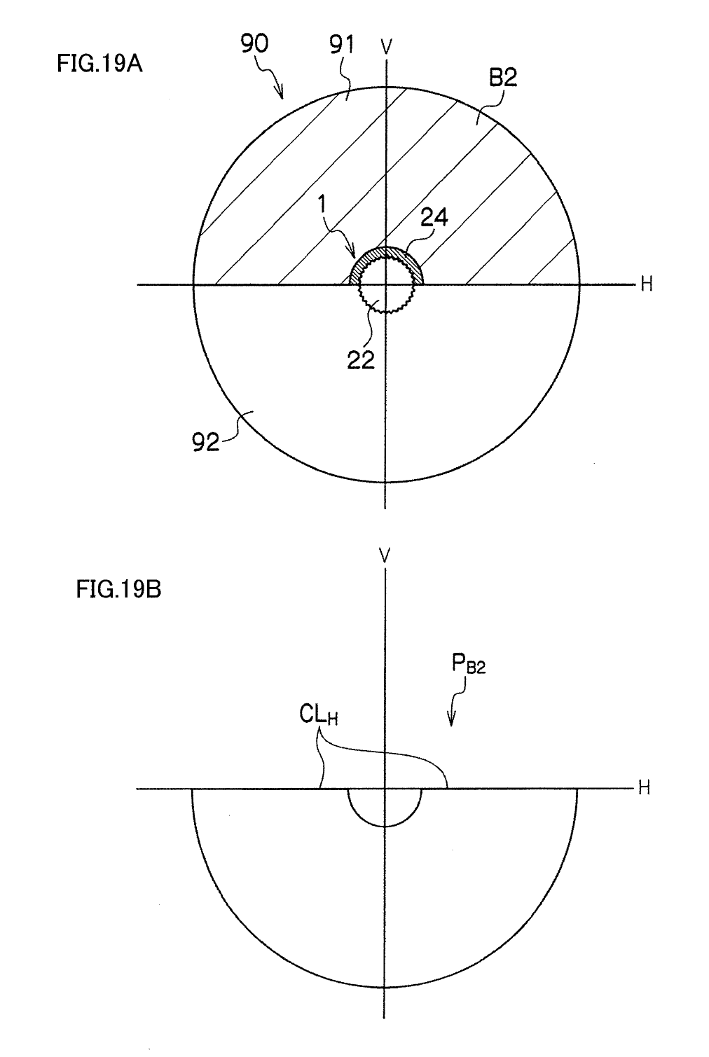

When constructing the vehicle light 90 using the laser light source device 1 (with the phosphor-containing resin 24 having an application area θ1=180 degrees) as the upper laser light source device 1 (refer to FIG. 19A), as shown in FIG. 19A, light radiated from the upper laser light source device 1 enters, and is reflected by, a region B2 (a region indicated by hatching in FIG. 19A) corresponding to the phosphor-containing resin 24 among the reflection surface 91 and the reflection surface 92, and is irradiated forward (an image of the region B2 is projected forward as a vertically and horizontally inverted image). Accordingly, as shown in FIG. 19B, a light distribution pattern P_{B2} having a horizontal cutoff CL_{H} can be formed on the virtual vertical screen that directly faces the reflection surfaces 91 and 92.

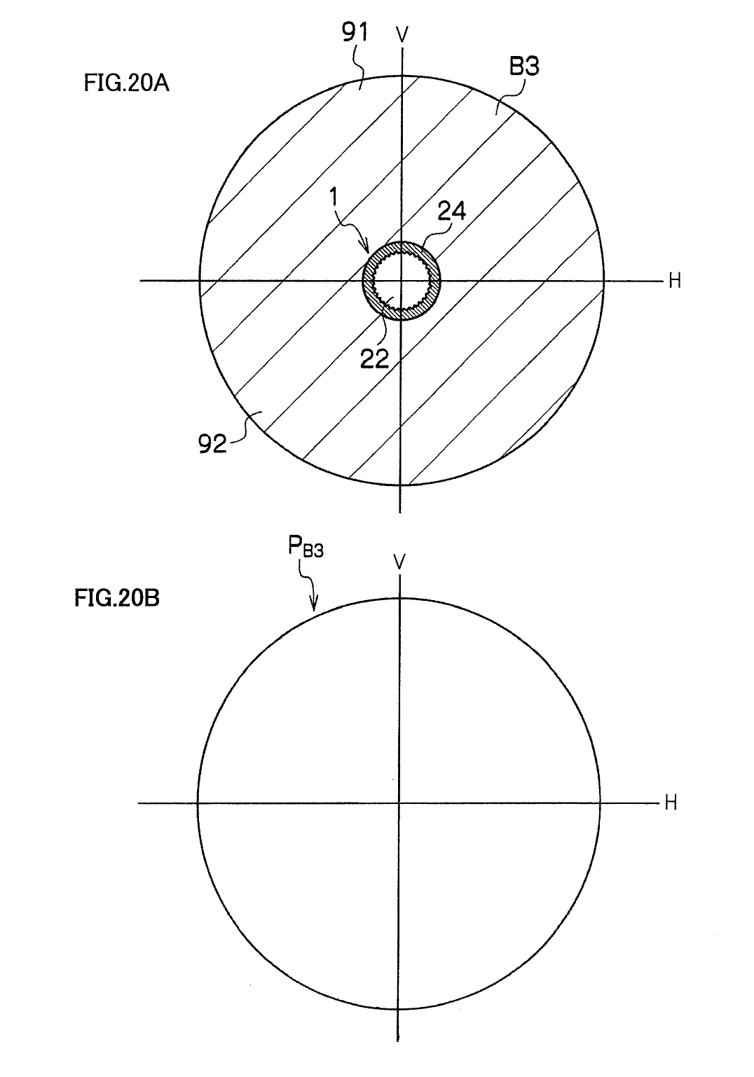

In addition, when constructing the vehicle light 90 using the laser light source device 1 (with the phosphor-containing resin 24 having an application area θ1=360 degrees) as the upper laser light source device 1 (refer to FIG. 20A), as shown in FIG. 20A, light radiated from the upper laser light source device 1 enters, and is reflected by, a region B3 (a region indicated by hatching in FIG. 20A) corresponding to the phosphor-containing resin 24 among the reflection surface 91 and the reflection surface 92, and is irradiated forward (an image of the region B3 is projected forward as a vertically and horizontally inverted image). Accordingly, as shown in FIG. 20B, an approximately circular light distribution pattern P_{B3} can be formed on the virtual vertical screen that directly faces the reflection surfaces 91 and 92.

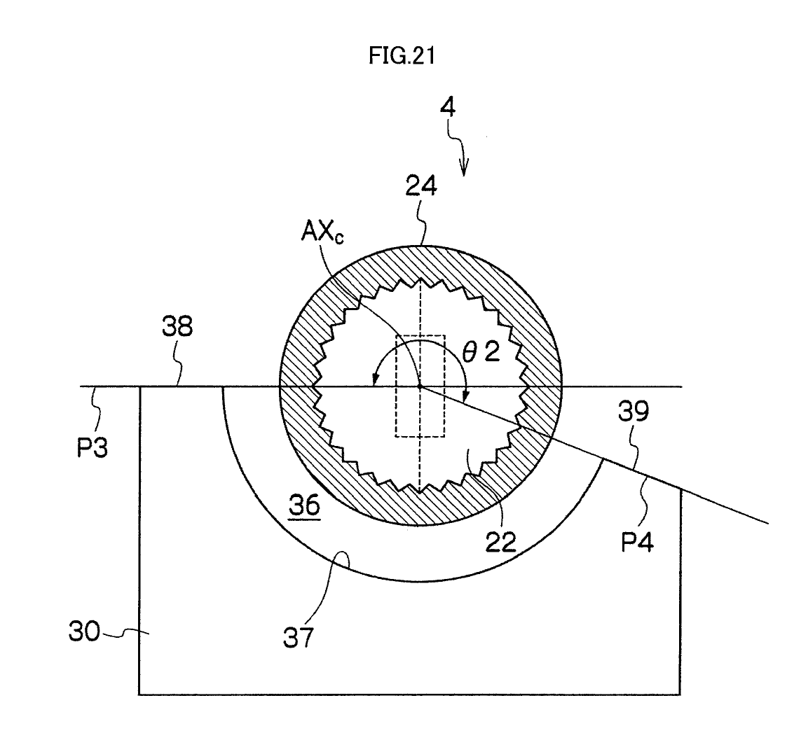

Furthermore, the vehicle light 90 may be constructed using the laser light source device 4 (with the phosphor-containing resin 24 having an application area θ1=360 degrees) instead of the upper laser light source device 1. As shown in FIG. 21, a heat sink stand 30 of the laser light source device 4 includes a horizontal surface 38 cut by a third plane P3 (a horizontal plane) including a cylindrical axis AXc of a light-guiding part 22 and a diagonal surface 39 cut by a fourth plane P4 which includes the cylindrical axis AXc of the light-guiding part 22 and which is inclined by θ2=195 degrees with respect to the third plane P3.

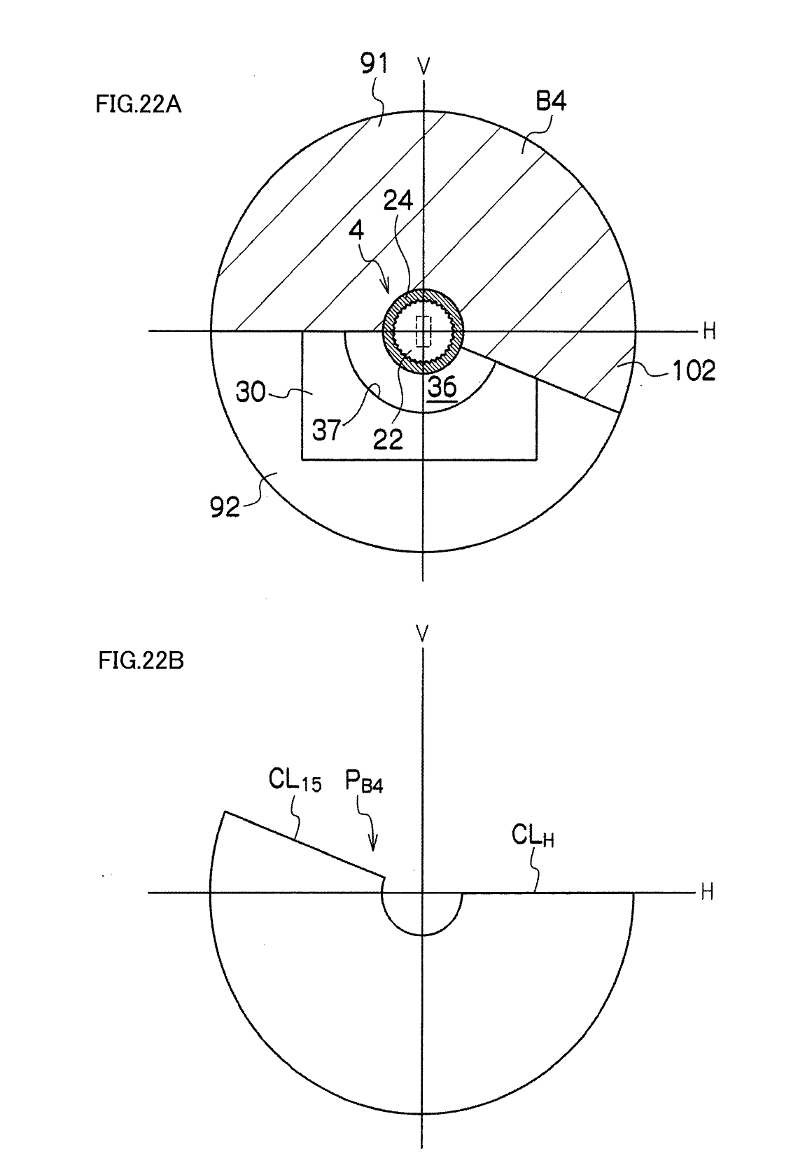

Accordingly, as shown in FIG. 22A, light radiated from the laser light source device 4 enters, and is reflected by, a region B4 (a region indicated by hatching in FIG. 22A) corresponding to the phosphor-containing resin 24 among the reflection surface 91 and the reflection surface 92, and is irradiated forward (an image of the region B4 is projected forward as a vertically and horizontally inverted image). As a result, as shown in FIG. 22B, a low-beam light distribution pattern P_{B4} having a horizontal cutoff CL_{H} and a 15-degree diagonal cutoff CL₁₅ is formed on the virtual vertical screen that directly faces the reflection surfaces 91 and 92.

Moreover, the application area θ1 (the light-emitting region a) of the phosphor-containing resin 24 can be adjusted as appropriate.

Furthermore, the lower laser light source device 1 and the reflection surface 92 or the upper laser light source device 4 and the reflection surface 91 can be omitted.

It is to be understood that the forgoing embodiments are merely illustrative in all aspects thereof and are not to be construed as limiting the present invention. Therefore, the present invention can be implemented in various other specific forms without departing from the spirit and essential features of the invention.

This application is based on Japanese Patent Application No. 2011-064540 which is incorporated herein by reference.

What is claimed is:

1. A vehicle light comprising a laser light source device and an optical system configured so as to form a predetermined light distribution pattern using light radiated from the laser light source device, wherein
the laser light source device includes:
a light-guiding part which is a cylindrical light-guiding part made of a light-transmissive member, and has a surface that includes one end surface including a light-introducing surface for introducing a laser beam into the light-guiding part, an outer circumferential surface, and another end surface, a diffusing surface being set in a region on the surface other than the light-introducing surface;
a phosphor arranged in a light-emitting region on the outer circumferential surface, the light-emitting region being enclosed by a first plane including a cylindrical axis of the light-guiding part and a second plane including the cylindrical axis of the light-guiding part and inclined by a predetermined angle with respect to the first plane;
a reflective film arranged in a region on the surface other than the light-introducing surface and the light-emitting region; and
a laser light source that outputs a laser beam which is introduced into the light-guiding part from the light-introducing surface, is diffused by the diffusing surface, exits the light-emitting region as a diffused light and enters the phosphor, and
the light-guiding part and the laser light source are arranged adjacent to each other.

2. The vehicle light according to claim 1, wherein irregularities with a vertical angle of 90 degrees or less are formed in the light-emitting region.

3. The vehicle light according to claim 1, wherein a polarizing filter for transmitting a laser beam outputted from the laser light source is arranged between the laser light source and the light-introducing surface.

4. The vehicle light according to claim 1, wherein an antireflective film configured by alternately laminating two layers with different refractive indexes is arranged between the laser light source and the polarizing filter.

5. The vehicle light according to claim 1, wherein
the optical system includes:
a reflection surface which is arranged in front of the laser light source device so that light radiated from the laser light source device enters the reflection surface and which reflects light incident from the laser light source device as a converging beam that forms a low-beam light distribution pattern;
a projection lens that is arranged in front of the reflection surface so that light reflected by the reflection surface is transmitted through the projection lens; and
a shade that is arranged between the reflection surface and the projection lens so as to block a part of the light reflected by the reflection surface and form a cutoff of the low-beam light distribution pattern.

6. The vehicle light according to claim 1, wherein
the optical system includes:
a reflection surface which is arranged in front of the laser light source device so that light radiated from the laser light source device enters the reflection surface and which reflects light incident from the laser light source device as a converging beam that forms a high-beam light distribution pattern; and
a projection lens that is arranged in front of the reflection surface so that light reflected by the reflection surface is transmitted through the projection lens.

7. The vehicle light according to claim 1, wherein the phosphor is arranged in the light-emitting region on the outer circumferential surface, the light-emitting region being enclosed by the first plane and the second plane which is inclined by 180 degrees or 360 degrees with respect to the first plane.

8. The vehicle light according to claim 1, wherein
the optical system is a parabolic reflection surface arranged above a vehicle light optical axis,
the laser light source device is arranged so that an optical axis thereof coincides with the vehicle light optical axis, and
a focal point of the parabolic reflection surface is set in a vicinity of a rear end portion of the light-guiding part.

9. The vehicle light according to claim 1, wherein
the optical system is a parabolic reflection surface arranged below a vehicle light optical axis,
the laser light source device is arranged so that an optical axis thereof coincides with the vehicle light optical axis, and
a focal point of the parabolic reflection surface is set in a vicinity of a front end portion of the light-guiding part.

10. The vehicle light according to claim 8, wherein the phosphor is arranged in the light-emitting region on the outer circumferential surface, the light-emitting region being enclosed by the first plane and the second plane which is inclined by 180 degrees, 195 degrees, or 360 degrees with respect to the first plane.

11. The vehicle light according to claim 1, wherein
the phosphor is arranged in the light-emitting region on the outer circumferential surface, the light-emitting region being enclosed by the first plane and the second plane which is inclined by 360 degrees with respect to the first plane, and
the vehicle light further comprises a reflection surface arranged around the outer circumferential surface of the light-guiding part at an interval from the outer circumferential surface.

12. The vehicle light according to claim 8, wherein
the phosphor is arranged in the light-emitting region on the outer circumferential surface, the light-emitting region being enclosed by the first plane and the second plane which is inclined by 360 degrees with respect to the first plane,
the vehicle light further comprises:
a reflection surface arranged around the outer circumferential surface of the light-guiding part at an interval from the outer circumferential surface; and
a heat sink stand on which the light-guiding part and the laser light source are arranged adjacent to each other and which is formed with a reflection surface arranged around the outer circumferential surface of the light-guiding part, and
the heat sink stand includes a horizontal surface cut by a third plane including the cylindrical axis of the light-guiding part and a diagonal surface cut by a fourth plane including the cylindrical axis of the light-guiding part and inclined by 195 degrees with respect to the third plane.

13. The vehicle light according to claim 1, further comprising a heat sink stand on which the light-guiding part and the laser light source are arranged adjacent to each other.

14. The vehicle light according to claim 12, further comprising a heat sink substrate that includes a slide-in structure to which the heat sink stand is detachably mounted.

15. The vehicle light according to claim 1, wherein the light-guiding part has an outer diameter of 0.3 to 2 mm and a length of 0.3 to 6 mm.
